(19) United States
(12) Patent Application Publication
(10) Pub. No.: US 2026/0370699 A1
(43) Pub. Date: Nov. 19, 2026

(54) ELECTRONIC DEVICE AND METHOD FOR ESTABLISHING SESSION

(71) Applicant: Samsung Electronics Co., Ltd., Suwon-si (KR)

(72) Inventor: Kwangtae SEO, Suwon-si (KR)

(21) Appl. No.: 19/742,690

(22) Filed: Jul. 15, 2026

Related U.S. Application Data
(63) Continuation of application No. PCT/KR2025/000674, filed on Jan. 10, 2025.

(30) Foreign Application Priority Data
Jan. 17, 2024 (KR) 10-2024-0007645
Feb. 2, 2024 (KR) 10-2024-0016949

(51) Int. Cl. H04L 65/1069

(52) U.S. Cl. CPC H04L 65/1069

(57) ABSTRACT

A method performed by a client server is provided. The method includes establishing a first session with a radio unit (RU) by using first connection information, which is connection information of the client server, changing the connection information of the client server from the first connection information to second connection information while the first session is established, transmitting the second connection information to the RU so that connection information of the RU is changed from the first connection information to the second connection information, receiving, from the RU, a message for performing a call home for the client server, determining whether a reset process of the RU has been identified, and determining whether to use the second connection information in order to establish a second session with the RU according to whether a reset process of the RU has been identified.

### CROSS-REFERENCE TO RELATED APPLICATION(S)

This application is a continuation application, claiming priority under 35 U.S.C. § 365(c), of an International application No. PCT/KR2025/000674, filed on Jan. 10, 2025, which is based on and claims the benefit of a Korean patent application number 10-2024-0007645, filed on Jan. 17, 2024, in the Ministry of Intellectual Property (MOIP), and of a Korean patent application number 10-2024-0016949, filed on Feb. 2, 2024, in the Ministry of Intellectual Property (MOIP), the disclosure of each of which is incorporated by reference herein in its entirety.

### BACKGROUND

### 1. Field

The disclosure relates to an electronic device and a method for establishing a session.

### 2. Description of Related Art

As a transmission capacity increases in a wireless communication system, a function split for functionally splitting a base station is being applied. According to the function split, the base station may be split into a distributed unit (DU) and a radio unit (RU). A fronthaul interface is defined for communication between the DU and the RU.

The above information is presented as background information only to assist with an understanding of the disclosure. No determination has been made, and no assertion is made, as to whether any of the above might be applicable as a prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for establishing a session.

Additional aspects will be set forth in part in the description which follows and, in part, will be apparent from the description, or may be learned by practice of the presented embodiments.

In accordance with an aspect of the disclosure, a client server is provided. The client server includes a transceiver, memory, comprising one or more storage media, storing instructions, and at least one processor comprising processing circuitry communicatively coupled to the transceiver and the memory, wherein the instructions, when executed by the at least one processor individually or collectively, cause the client server to establish a first session with a radio unit (RU) using first connection information which is connection information of the client server, while the first session is established, change the connection information of the client server from the first connection information to second connection information, transmit, to the RU, the second connection information to change connection information of the RU from the first connection information to the second connection information, based on transmitting the second connection information to the RU, receive, from the RU, a message for performing call home to the client server, in response to receiving the message, determine whether a reset process of the RU is identified, and according to whether the reset process of the RU has been identified, determine whether to use the second connection information to establish a second session with the RU.

In accordance with another aspect of the disclosure, a radio unit (RU) is provided. The RU includes a transceiver, memory, comprising one or more storage media, storing instructions, and at least one processor comprising processing circuitry communicatively coupled to the transceiver and the memory, wherein the instructions, when executed by the at least one processor individually or collectively, cause the RU to establish a first session with a client server using first connection information which is connection information of the RU, while the first session is established, receive second connection information from the client server, based on receiving the second connection information, change the connection information of the RU from the first connection information to the second connection information, after the connection information of the RU is changed from the first connection information to the second connection information, in response to identifying an anomaly of the RU, perform a reset process, and after the reset process is performed, transmit, to the client server, a message for performing call home to the client server configured based on the first connection information.

In accordance with another aspect of the disclosure, a method performed by a client server is provided. The method includes establishing a first session with a radio unit (RU) using first connection information which is connection information of the client server, while the first session is established, changing the connection information of the client server from the first connection information to second connection information, transmitting, to the RU, the second connection information to change connection information of the RU from the first connection information to the second connection information, based on transmitting the second connection information to the RU, receiving, from the RU, a message for performing call home to the client server, in response to receiving the message, determining whether a reset process of the RU is identified, and according to whether the reset process of the RU has been identified, determining whether to use the second connection information to establish a second session with the RU.

In accordance with another aspect of the disclosure, a method performed by a radio unit (RU) is provided. The method includes establishing a first session with a client server using first connection information which is connection information of the RU, while the first session is established, receiving second connection information from the client server, based on receiving the second connection information, changing the connection information of the RU from the first connection information to the second connection information, after the connection information of the RU is changed from the first connection information to the second connection information, in response to identifying an anomaly of the RU, performing a reset process, after the reset process is performed, and transmitting, to the client server, a message for performing call home to the client server configured based on the first connection information.

In accordance with another aspect of the disclosure, one or more non-transitory computer-readable storage media storing one or more computer programs including computer-executable instructions that, when executed by one or more processors of a client server individually or collectively, cause the client server to perform operations are provided. The operations include establishing a first session with a radio unit (RU) using first connection information which is connection information of the client server, while the first session is established, changing the connection information of the client server from the first connection information to second connection information, transmitting, to the RU, the second connection information to change connection information of the RU from the first connection information to the second connection information, based on transmitting the second connection information to the RU, receiving, from the RU, a message for performing call home to the client server, in response to receiving the message, determining whether a reset process of the RU is identified, and according to whether the reset process of the RU has been identified, determining whether to use the second connection information to establish a second session with the RU.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a wireless communication system according to an embodiment of the disclosure;

FIG. 2A illustrates a fronthaul interface according to an embodiment of the disclosure;

FIG. 2B illustrates a fronthaul interface of an open (O)-radio access network (RAN) according to an embodiment of the disclosure;

FIG. 3A illustrates a functional configuration of a distributed unit (DU) according to an embodiment of the disclosure;

FIG. 3B illustrates a functional configuration of a radio unit (RU) according to an embodiment of the disclosure;

FIG. 4 illustrates an example of a function split between a DU and a RU according to an embodiment of the disclosure;

FIG. 5 illustrates an example of an architecture for a function split between a DU and a RU according to an embodiment of the disclosure;

FIG. 6A illustrates an example of a management plane configured based on a hierarchical model according to an embodiment of the disclosure;

FIG. 6B illustrates an example of a management plane configured based on a hybrid model according to an embodiment of the disclosure;

FIG. 7 illustrates examples of management plane interfaces according to an embodiment of the disclosure;

FIG. 8 illustrates an example of an operation related to “start up” installation according to an embodiment of the disclosure;

FIG. 9 illustrates an example of an operation related to “call home” according to an embodiment of the disclosure;

FIG. 10 illustrates an example of an operation for monitoring a NETCONF connection according to an embodiment of the disclosure;

FIG. 11 illustrates an example of an operation of a NETCONF client and a NETCONF server for establishing a session in a case that connection information is changed according to an embodiment of the disclosure;

FIG. 12A illustrates an example of an operation of a NETCONF client and a NETCONF server in a case that a reset process is performed in the NETCONF server after connection information is changed according to an embodiment of the disclosure;

FIG. 12B illustrates an example of an operation of a NETCONF client and a NETCONF server in a case that an anomaly occurs in second connection information in the NETCONF server after connection information is changed according to an embodiment of the disclosure;

FIG. 13 is a flowchart related to an operation of a NETCONF client in a case that connection information is changed according to an embodiment of the disclosure;

FIG. 14 is a flowchart related to an operation of a NETCONF server in a case that connection information is changed according to an embodiment of the disclosure;

FIG. 15 is a flowchart related to an operation of a client server in a case that connection information is changed according to an embodiment of the disclosure;

FIG. 16 is a flowchart related to an operation of an RU in a case that connection information is changed according to an embodiment of the disclosure; and

FIG. 17 is a flowchart related to an operation of an RU in a case that connection information is changed according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

A term referring to a signal (e.g., a signal, information, a message, or signaling), a term referring to a resource (e.g., a symbol, a slot, a subframe, a radio frame, a subcarrier, a resource element (RE), a resource block (RB), a bandwidth part (BWP), or an occasion), a term for a computation state (e.g., a step, an operation, or a procedure), a term referring to data (e.g., a packet, a user stream, information, a bit, a symbol, or a codeword), a term referring to a channel, a term referring to network entities, a term referring to a component of a device, and the like used in the following descriptions are exemplified for convenience of description. Therefore, the disclosure is not limited to terms described below, and another term having an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

Although the disclosure describes various embodiments using terms used in some communication standards (e.g., 3rd Generation Partnership Project (3GPP), extensible radio access network (xRAN), open-radio access network (O-RAN)), these are only examples for explanation. The various embodiments of the disclosure may be easily modified and applied to other communication systems.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

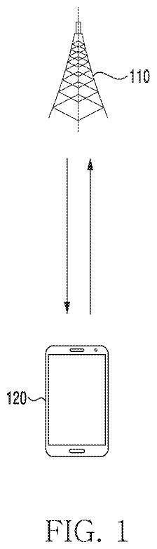

FIG. 1 illustrates a wireless communication system according to an embodiment of the disclosure.

Referring to FIG. 1, FIG. 1 illustrates a base station 110 and a terminal 120 as a portion of nodes that utilize a wireless channel in a wireless communication system. FIG. 1 illustrates only one base station, but a wireless communication system may further include another base station that is identical or similar to the base station 110.

The base station 110 is a network infrastructure that provides wireless access to the terminal 120. The base station 110 has coverage defined based on a distance at which a signal may be transmitted. In addition to ‘base station’, the base station 110 may be referred to as an ‘access point (AP)’, ‘eNodeB (eNB)’, ‘5th generation node’, ‘next generation nodeB (gNB)’, ‘wireless point’, ‘transmission/reception point (TRP)’ or other terms having equivalent technical meanings.

The terminal 120, which is a device used by a user, performs communication with the base station 110 through a wireless channel. A link from the base station 110 to the terminal 120 is referred to as a downlink (DL), and a link from the terminal 120 to the base station 110 is referred to as an uplink (UL). In addition, although not illustrated in FIG. 1, the terminal 120 and another terminal may perform communication with each other through a wireless channel. At this time, a link (device-to-device link (D2D)) between the terminal 120 and the other terminal is referred to as a sidelink, and the sidelink may be used interchangeably with a PC5 interface. In some other embodiments, the terminal 120 may be operated without the user's involvement. According to an embodiment, the terminal 120, which is a device performing machine type communication (MTC), may not be carried by the user. Additionally, according to an embodiment, the terminal 120 may be a narrowband (NB)-internet of things (IoT) device.

In addition to ‘terminal’, the terminal 120 may also be referred to as ‘user equipment (UE)’, ‘customer premises equipment, (CPE)’, ‘mobile station’, ‘subscriber station’, ‘remote terminal’, ‘wireless terminal’, ‘electronic device’, ‘user device’, or other terms having equivalent technical meanings.

The base station 110 may perform beamforming with the terminal 120. The base station 110 and the terminal 120 may transmit and receive a wireless signal in a relatively low frequency band (e.g., frequency range 1 (FR 1) of NR). In addition, the base station 110 and the terminal 120 may transmit and receive a wireless signal in a relatively high frequency band (e.g., FR 2 (or FR 2-1, FR 2-2, FR 2-3) or FR 3), and a millimeter wave (mmWave) band (e.g., 28 GHz, 30 GHz, 38 GHz, 60 GHz). The base station 110 and the terminal 120 may perform beamforming to improve a channel gain. Herein, the beamforming may include transmission beamforming and reception beamforming. The base station 110 and the terminal 120 may provide directivity to a transmission signal or a reception signal. To this end, the base station 110 and the terminal 120 may select serving beams through a beam search or beam management procedure. After the serving beams are selected, subsequent communication may be performed through a resource in a QCL relationship with the resource transmitting the serving beams.

If large-scale characteristics of a channel carrying a symbol on a first antenna port may be inferred from a channel carrying a symbol on a second antenna port, the first antenna port and the second antenna port may be evaluated to be in the QCL relationship. For example, large-scale characteristics may include at least one of a delay spread, a Doppler spread, a Doppler shift, an average gain, an average delay, and a spatial receiver parameter.

Although FIG. 1 describes that both the base station 110 and the terminal 120 perform beamforming, the embodiments of the disclosure are not necessarily limited thereto. In some embodiments, the terminal may or may not perform beamforming. In addition, the base station may or may not perform beamforming. That is, either only one of the base station and the terminal may perform beamforming, or neither the base station nor the terminal may perform beamforming.

In the disclosure, a beam refers to a spatial flow of a signal in a wireless channel, and is formed by one or more antennas (or antenna elements), and this formation process may be referred to as beamforming. Beamforming may include at least one of analog beamforming or digital beamforming (e.g., precoding). A reference signal transmitted based on beamforming may include, for example, a demodulation-reference signal (DM-RS), a channel state information-reference signal (CSI-RS), a synchronization signal/physical broadcast channel (SS/PBCH), and a sounding reference signal (SRS). In addition, an IE such as CSI-RS resource or SRS-resource may be used as a configuration for each reference signal, and this configuration may include information associated with the beam. The information associated with the beam may mean whether a corresponding configuration (e.g., CSI-RS resource) uses the same spatial domain filter as another configuration (e.g., another CSI-RS resource within the same CSI-RS resource set) or a different spatial domain filter, or which reference signal it is quasi-co-located (QCL) with, and if so, what type it is (e.g., QCL type A, B, C, D).

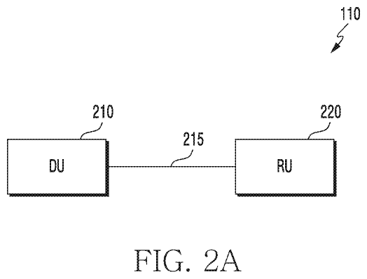

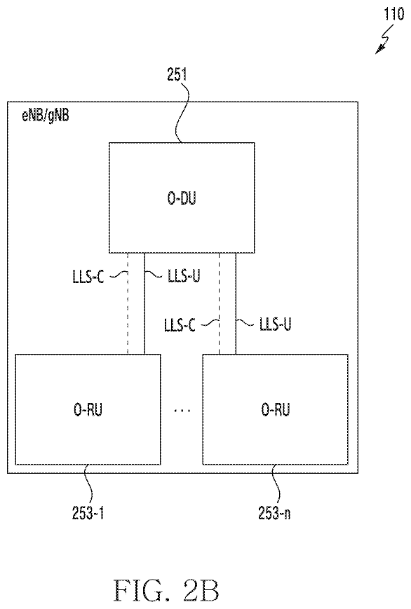

Conventionally, in a communication system with a relatively large cell radius of base station, each base station was installed to include a function of a digital processing unit (or distributed unit (DU)) and a radio frequency (RF) processing unit (or radio unit (RU)). However, as high frequency bands are used in 4th generation (4G) and/or subsequent communication systems (e.g., 5th generation (5G)) and the cell coverage of base stations is reduced, the number of base stations to cover a specific area has increased. The burden of installation cost for operators to install base stations has also increased. In order to minimize the installation cost of a base station, a structure in which the DU and RU of the base station are separated, one or more RUs are connected to one DU through a wired network, and one or more Rus geographically distributed to cover a specific area are deployed, has been proposed. Hereinafter, a deployment structure and expansion examples of a base station according to various embodiments of the disclosure are described through FIGS. 2A and 2B.

FIG. 2A illustrates a fronthaul interface according to an embodiment of the disclosure. Unlike a backhaul between a base station and a core network, the fronthaul refers to a link between entities between a wireless LAN and a base station. FIG. 2A illustrates an example of a fronthaul structure between one DU 210 and one RU 220, but this is only for convenience of explanation and the disclosure is not limited thereto. In other words, the embodiments of the disclosure may also be applied to a fronthaul structure between one DU and a plurality of RU. For example, the embodiments of the disclosure may be applied to a fronthaul structure between one DU and two RU. In addition, the embodiments of the disclosure may also be applied to a fronthaul structure between one DU and three RU.

Referring to FIG. 2A, the base station 110 may include a DU 210 and an RU 220. A fronthaul 215 between the DU 210 and the RU 220 may be operated via an Fx interface. For operation of the fronthaul 215, an interface such as an enhanced common public radio interface (eCPRI) or radio over ethernet (ROE) may be used.

As communication technology has been developed, mobile data traffic increased, and thus the bandwidth demand required in a fronthaul between a digital unit and a radio unit has increased significantly. In a deployment such as centralized/cloud radio access network (C-RAN), the DU may be implemented to perform functions for packet data convergence protocol (PDCP), radio link control (RLC), media access control (MAC), and physical (PHY), and the RU may be implemented to further perform functions for PHY layer in addition to a radio frequency (RF) function.

The DU 210 may be in charge of upper layer functions of a wireless network. For example, the DU 210 may perform functions of the MAC layer and apart of the PHY layer. Herein, a part of the PHY layer is a function performed at a higher level among the functions of the PHY layer, and may include, for example, channel encoding (or channel decoding), scrambling (or descrambling), modulation (or demodulation), and layer mapping (or layer demapping). According to an embodiment, if the DU 210 complies with an O-RAN standard, it may be referred to as an O-RAN DU (O-DU). The DU 210 may be replaced with and represented as a first network entity for a base station (e.g., gNB) in embodiments of the disclosure, as needed.

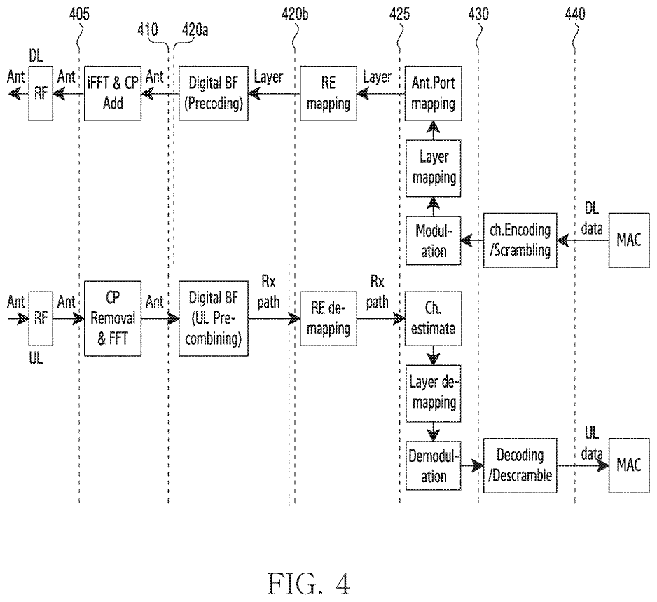

The RU 220 may be in charge of lower layer functions of a wireless network. For example, the RU 220 may perform a part of the PHY layer, and a RF function. Herein, a part of the PHY layer is a function performed at performed at a relatively lower level than the DU 210 among the functions of the PHY layer, and may include, for example, iFFT conversion (or FFT conversion), cyclic prefix (CP) insertion (or CP removal), and digital beamforming. In FIG. 4, an example of such a specific function split is described in detail. The RU 220 may be referred to as access unit (AU), access point (AP), transmission/reception point (TRP), remote radio head (RRH), radio unit (RU), or other terms having equivalent technical meanings. According to an embodiment, if the RU 220 complies with the O-RAN standard, it may be referred to as an O-RAN RU (O-RU). The RU 220 may be replaced with and represented as a second network entity for a base station (e.g., gNB) in embodiments of the disclosure, as needed.

Although FIG. 2A describes that the base station 110 includes the DU 210 and the RU 220, the embodiments of the disclosure are not limited thereto. The base station according to the embodiments may be implemented in a distributed deployment according to a centralized unit (CU) configured to perform functions of upper layers (e.g., packet data convergence protocol (PDCP), radio resource control (RRC)) of an access network and a distributed unit (DU) configured to perform functions of lower layers. At this time, the distributed unit (DU) may include the digital unit (DU) and the radio unit (RU) of FIG. 1. Between a core (e.g., 5G core (5GC) or next generation core (NGC)) network and a radio access network (RAN), the base station may be implemented in a structure in which CU, DU, and RU are arranged in order. An interface between the CU and the distributed unit (DU) may be referred to as an F1 interface.

A centralized unit (CU) may be in charge of functions of a higher layer than the DU, by being connected to one or more DUs. For example, the CU may be in charge of radio resource control (RRC) and a function of a packet data convergence protocol (PDCP) layer, and the DU and the RU may be in charge of functions of lower layers. The DU may perform radio link control (RLC), media access control (MAC), and some functions (high PHY) of PHY layer, and the RU may perform remaining functions (low PHY) of the PHY layer. In addition, as an example, a digital unit (DU) may be included in a distributed unit (DU) according to the implementation of distributed deployment of the base station. Hereinafter, unless otherwise defined, it is described as operations of the digital unit (DU) and the RU, but various embodiments of the disclosure may be applied to both of a base station arrangement including the CU or an arrangement where the DU is directly connected to a core network (i.e., the CU and the DU are integrated into a base station (e.g., NG-RAN node) which is a single entity).

FIG. 2B illustrates a fronthaul interface of an open (O)-radio access network (RAN) according to an embodiment of the disclosure. As a base station 110 according to distributed deployment, eNB or gNB is exemplified.

Referring to FIG. 2B, the base station 110 may include an O-DU 251 and O-RUs 253-1, . . . , and 253-n. Hereinafter, for convenience of explanation, an operation and a function of the O-RU 253-1 may be understood as a description of each of other O-RUs (e.g., O-RU 253-n).

The O-DU 251 is a logical node including functions among functions of a base station (e.g., eNB, gNB) according to FIG. 4 to be described later, except for functions allocated exclusively to the O-RU 253-1. The O-DU 251 may control operations of the O-RUs 253-1, . . . , and 253-n. The O-DU 251 may be referred to as a lower layer split (LLS) central unit (CU). The O-RU 253-1 is a logical node including a subset among the functions of a base station (e.g., eNB, gNB) according to FIG. 4 to be described later. The real-time aspect of the control plane (C-plane) communication and user plane (U-plane) communication with the O-RU 253-1 may be controlled by the O-DU 251.

The O-DU 251 may perform communication with the O-RU 253-1 through an LLS interface. The LLS interface corresponds to a fronthaul interface. The LLS interface refers to a logical interface between the O-DU 251 and the O-RU 253-1 using lower layer functional split (i.e., intra-PHY-based functional split). The LLS-C between the O-DU 251 and the O-RU 253-1 provides a C-plane through the LLS interface. The LLS-U between the O-DU 251 and the O-RU 253-1 provides a U-plane through the LLS interface.

In FIG. 2B, entities of the base station 110 have been described as O-DU and O-RU to describe O-RAN. However, these designations are not to be construed as limiting the embodiments of the disclosure. In embodiments described below, operations of the DU 210 may also be performed by the O-DU 251. A description of the DU 210 may be applied to the O-DU 251. Likewise, in embodiments described below, operations of the RU 220 may also be performed by the O-RU 253-1. A description of the RU 220 may be applied to the O-RU 253-1.

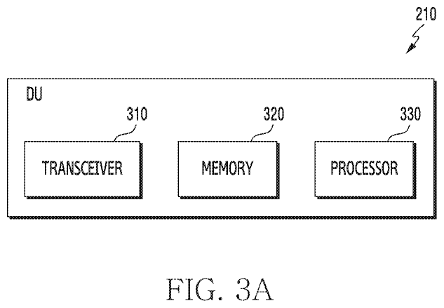

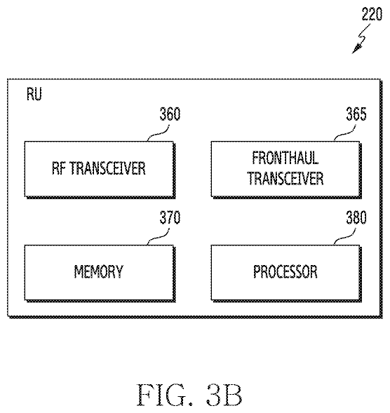

FIG. 3A illustrates a functional configuration of a distributed unit (DU) according to an embodiment of the disclosure. A configuration exemplified in FIG. 3A, which is as a part of a base station, may be understood as a configuration of the DU 210 of FIG. 2A (or the O-DU 251 of FIG. 2B). Hereinafter, the terms ‘ . . . unit’ and ‘ . . . er’ used below refer to a unit processing at least one function or operation, which may be implemented by hardware or software, or a combination of hardware and software.

Referring to FIG. 3A, a DU 210 includes a transceiver 310, memory 320, and a processor 330.

The transceiver 310 may perform functions for transmitting and receiving a signal in a wired communication environment. The transceiver 310 may include a wired interface for controlling a direct device-to-device connection through a transmission medium (e.g., copper wire, optical fiber). For example, the transceiver 310 may transmit an electrical signal to another device through a copper wire or perform conversion between an electrical signal and an optical signal. The DU 210 may communicate with a radio unit (RU) through the transceiver 310. The DU 210 may be connected to a core network or a CU of a distributed deployment through the transceiver 310.

The transceiver 310 may also perform functions for transmitting and receiving a signal in a wireless communication environment. For example, the transceiver 310 may perform a conversion function between a baseband signal and a bit string according to a physical layer specification of a system. For example, upon transmitting data, the transceiver 310 generates complex-valued symbols by encoding and modulating a transmission bit string. In addition, upon receiving data, the transceiver 310 restores a received bit string by demodulating and decoding a baseband signal. In addition, the transceiver 310 may include a plurality of transmission/reception paths. In addition, according to an embodiment, the transceiver 310 may be connected to a core network or to other nodes (e.g., integrated access backhaul (IAB)).

The transceiver 310 may transmit and receive a signal. For example, the transceiver 310 may transmit a management plane (M-plane) message. For example, the transceiver 310 may transmit a synchronization plane (S-plane) message. For example, the transceiver 310 may transmit a control plane (C-plane) message. For example, the transceiver 310 may transmit a user plane (U-plane) message. For example, the transceiver 310 may receive the U-plane message. Although only the transceiver 310 is illustrated in FIG. 3A, the DU 210 may include two or more transceivers according to another implementation.

The transceiver 310 transmits and receives a signal as described above. Accordingly, all or some of the transceiver 310 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the transceiver 310.

Although not illustrated in FIG. 3A, the transceiver 310 may further include a backhaul transceiver for connection with a core network or another base station. The backhaul transceiver provides an interface for performing communication with other nodes in the network. In other words, the backhaul transceiver converts a bit string transmitted from a base station to another node, such as another access node, another base station, an upper node, and a core network into a physical signal, and converts a physical signal received from another node into a bit string.

The memory 320 stores a basic program, an application program, and data such as configuration information for an operation of the DU 210. The memory 320 may be referred to as a storage unit. The memory 320 may be configured with volatile memory, nonvolatile memory, or a combination of the volatile memory and the nonvolatile memory. In addition, the memory 320 provides stored data according to a request from the processor 330.

The processor 330 controls overall operations of the DU 210. The processor 380 may be referred to as a control unit. For example, the processor 330 transmits and receives a signal through the transceiver 310 (or through a backhaul communication unit). In addition, the processor 330 writes and reads data in the memory 320. In addition, the processor 330 may perform functions of a protocol stack required in a communication standard. Although only the processor 330 is illustrated in FIG. 3A, the DU 210 may include two or more processors according to another implementation.

A configuration of the DU 210 illustrated in FIG. 3A is only an example, and an example of the DU performing the embodiments of the disclosure is not limited to the configuration illustrated in FIG. 3A. In some embodiment, some configurations may be added, deleted, or changed.

FIG. 3B illustrates a functional configuration of a radio unit (RU) according to an embodiment of the disclosure. A configuration exemplified in FIG. 3B, which is as a part of a base station, may be understood as a configuration of the RU 220 of FIG. 2B or the O-RU 253-1 of FIG. 2B. Hereinafter, the terms ‘ . . . unit’ and ‘ . . . er’ used below refer to a unit processing at least one function or operation, which may be implemented by hardware or software, or a combination of hardware and software.

Referring to FIG. 3B, the RU 220 includes an RF transceiver 360, a fronthaul transceiver 365, memory 370, and a processor 380.

The RF transceiver 360 performs functions for transmitting and receiving a signal through a wireless channel. For example, the RF transceiver 360 up-converts a baseband signal into an RF band signal and then transmits it through an antenna, and down-converts an RF band signal received through the antenna into a baseband signal. For example, the RF transceiver 360 may include a transmission filter, a reception filter, an amplifier, a mixer, an oscillator, a DAC, an ADC.

The RF transceiver 360 may include a plurality of transmission/reception paths. Furthermore, the RF transceiver 360 may include an antenna unit. The RF transceiver 360 may include at least one antenna array composed of a plurality of antenna elements. In terms of hardware, the RF transceiver 360 may be composed of a digital circuit and an analog circuit (e.g., a radio frequency integrated circuit (RFIC)). Herein, the digital circuit and the analog circuit may be implemented as a single package. In addition, the RF transceiver 360 may include a plurality of RF chains. The RF transceiver 360 may perform beamforming. In order to provide directivity to a signal to be transmitted and received according to the setting of the processor 380, the RF transceiver 360 may apply beamforming weights to the signal. According to an embodiment, the RF transceiver 360 may include a radio frequency (RF) block (or RF unit).

According to an embodiment, the RF transceiver 360 may transmit and receive a signal on a radio access network. For example, the RF transceiver 360 may transmit a downlink signal. The downlink signal may include a synchronization signal (SS), a reference signal (RS) (e.g., cell-specific reference signal (CRS), demodulation (DM)-RS), system information (e.g., MIB, SIB, remaining system information (RMSI), other system information (OSI)), configuration message, control information or downlink data. In addition, for example, the RF transceiver 360 may receive an uplink signal. The uplink signal may include a random access-related signal (e.g., random access preamble (RAP)) (or message 1 (Msg1), message 3 (Msg3)), a reference signal (e.g., sounding reference signal (SRS), DM-RS), or a power headroom report (PHR). Although only the RF transceiver 360 is illustrated in FIG. 3B, the RU 220 may include two or more RF transceivers according to another implementation.

According to embodiments, the RF transceiver 360 may transmit an RIM-RS. The RF transceiver 360 may transmit a first type of RIM-RS (e.g., RIM-RS type 1 of 3GPP) to inform the detection of remote interference. The RF transceiver 360 may transmit a second type of RIM-RS (e.g., RIM-RS type 2 of 3GPP) to inform the presence or absence of remote interference.

The fronthaul transceiver 365 may transmit and receive a signal. According to an embodiment, the fronthaul transceiver 365 may transmit and receive a signal on a fronthaul interface. For example, the fronthaul transceiver 365 may receive a management plane (M-plane) message. For example, the fronthaul transceiver 365 may receive a synchronization plane (S-plane) message. For example, the fronthaul transceiver 365 may receive a control plane (C-plane) message. For example, the fronthaul transceiver 365 may transmit a user plane (U-plane) message. For example, the fronthaul transceiver 365 may receive a U-plane message. Although only the fronthaul transceiver 365 is illustrated in FIG. 3B, the RU 220 may include two or more fronthaul transceivers according to another implementation.

As described above, the RF transceiver 360 and the fronthaul transceiver 365 transmit and receive a signal. Accordingly, all or some of the RF transceiver 360 and the fronthaul transceiver 365 may be referred to as a ‘communication unit’, a ‘transmission unit’, a ‘reception unit’, or a ‘transmission/reception unit’. In addition, in the following description, transmission and reception performed through a wireless channel are used to the meaning including that the processing as described above is performed by the RF transceiver 360. In the following description, transmission and reception performed through a wireless channel are used to the meaning including that the processing as described above is performed by the RF transceiver 360.

The memory 370 stores a basic program, an application program, and data such as configuration information for an operation of the RU 220. The memory 370 may be referred to as a storage unit. The memory 370 may be configured with volatile memory, nonvolatile memory, or a combination of the volatile memory and the nonvolatile memory. In addition, the memory 370 provides stored data according to a request from the processor 380. According to an embodiment, the memory 370 may include memory for a condition, a command, or a setting value related to an SRS transmission scheme.

The processor 380 controls overall operations of the RU 220. The processor 380 may be referred to as a control unit. For example, the processor 380 transmits and receives a signal through the RF transceiver 360 or the fronthaul transceiver 365. In addition, the processor 380 writes and reads data in the memory 370. In addition, the processor 380 may perform functions of a protocol stack required by a communication standard. Although only the processor 380 is illustrated in FIG. 3B, the RU 220 may include two or more processors according to another implementation. The processor 380, which is an instruction set or code stored in the memory 370, may be an instruction/code at least temporarily resided in the processor 380 or a storage space storing instruction/code, or part of circuitry constituting the processor 380. In addition, the processor 380 may include various modules for performing communication. The processor 380 may control the RU 220 to perform operations according to embodiments to be described later.

A configuration of the RU 220 illustrated in FIG. 3B is only an example, and an example of the RU performing the embodiments of the disclosure is not limited to the configuration illustrated in FIG. 3B. In some embodiment, some configurations may be added, deleted, or changed.

FIG. 4 illustrates an example of a function split between a DU and an RU according to an embodiment of the disclosure. As wireless communication technology advances (e.g., the introduction of 5th generation (5G) communication system (or new radio (NR) communication system)), the used frequency bands have increased further. As a cell radius of base stations became very small, the number of RUs required to be installed further increased. In addition, in the 5G communication system, as the amount of data transmitted has increased significantly by more than 10 times, a transmission capacity of a wired network transmitted to a fronthaul has increased significantly. Due to the above-described factors, the installation cost of a wired network in the 5G communication system may be increased significantly. Therefore, in order to reduce the transmission capacity of the wired network and reduce the installation cost of the wired network, a ‘function split’ to reduce a transmission capacity of the fronthaul by transferring some functions of the DU's modem to the RU may be used.

In order to reduce the burden on the DU, a role of the RU, which was in charge of only the existing RF function, may be extended to include some functions of a physical layer. As the RU performs functions of the higher layer, the throughput of the RU increases, which may increase a transmission bandwidth in the fronthaul while lowering the delay time requirement constraints due to response processing. On the other hand, as the RU performs the functions of the higher layer, a virtualization gain decreases and the size, weight, and cost of the RU increase. In consideration of the trade-off of the above-described advantages and disadvantages, it is required to implement an optimal function split.

Referring to FIG. 4, function splits in a physical layer below a MAC layer are illustrated. In a case of downlink (DL) transmitting signals to a terminal through a wireless network, a base station may sequentially perform channel encoding/scrambling, modulation, layer mapping, antenna mapping, RE mapping, digital beamforming (e.g., precoding), iFFT conversion/CP insertion, and RF conversion. In a case of uplink (UL) receiving signals from a terminal through the wireless network, the base station may sequentially perform RF conversion, FFT conversion/CP removal, digital beamforming (pre-combining), RE demapping, channel estimation, layer demapping, demodulation, decoding/discrambling. According to the above-described trade-off, the split of uplink functions and downlink functions may be defined in various types, by needs among vendors, discussion of standards, and the like.

In a first function split 405, the RU performs the RF function, and the DU performs the PHY function. The first function split is substantially such that the PHY function is not implemented within the RU, and as an example, it may be referred to as Option 8. In a second function split 410, the RU performs iFFT conversion/CP insertion in the DL of the PHY function and FFT conversion/CP removal in the UL, and the DU performs the remaining PHY functions. As an example, the second function split 410 may be referred to as Option 7-1. In a third function split 420a, the RU performs iFFT conversion/CP insertion in the DL of the PHY function and FFT conversion/CP removal and digital beamforming in the UL, and the DU performs the remaining PHY functions. As an example, the third function split 420a may be referred to as Option 7-2x Category A. In a fourth function split 420b, the RU performs digital beamforming in both DL and UL, and the DU performs upper PHY functions after digital beamforming. As an example, the fourth function split 420b may be referred to as Option 7-2x Category B. In a fifth function split 425, the RU performs RE mapping (or RE demapping) in both DL and UL, and the DU performs upper PHY functions after RE mapping (or RE demapping). As an example, the fifth function split 425 may be referred to as Option 7-2. In a sixth function split 430, the RU performs up to modulation (or demodulation) in both DL and UL, and the DU performs upper PHY functions after modulation (or demodulation). As an example, the sixth function split 430 may be referred to as Option 7-3. In a seventh function split 440, the RU performs up to encoding/scrambling (or decoding/discrambling) in both DL and UL, and the DU performs upper PHY functions after modulation (or demodulation). As an example, the seventh function split 440 may be referred to as option 6.

According to an embodiment, in a case that a large amount of signal processing is expected, such as in FR 1 MMU, a function split (e.g., the fourth function split 420b) in a relatively high layer may be required to reduce a fronthaul capacity. Additionally, in a function split (e.g., the sixth function split 430) at a too high layer, as a control interface becomes complex and multiple PHY processing blocks are included in the RU, which may cause a burden on the implementation of the RU, a suitable function split may be required according to the arrangement and implementation method of the DU and RU.

According to an embodiment, in a case that precoding of data received from the DU cannot be processed (i.e., in a case that there is a limit to the precoding capability of the RU), the third function split 420a or a lower function split (e.g., the second function split 410) may be applied. Conversely, in a case that there is a capability to process precoding of data received from the DU, the fourth function split 420b or a higher function split (e.g., the sixth function split 430) may be applied.

Hereinafter, unless otherwise specified, the embodiments in the disclosure are described based on the third function split 420a (it may be referred to as category A (CAT-A)), or the fourth function split 420b (it may be referred to as category B (CAT-B)) for performing beamforming processing in the RU. In the O-RAN standard, the type of O-RU is distinguished according to whether the precoding function is located at an interface of the O-DU or an interface of the O-RU. An O-RU in which precoding is not performed (i.e., low complexity) may be referred to as a CAT-A O-RU. An O-RU in which precoding is performed may be referred to as a CAT-B O-RU.

Hereinafter, an upper PHY means a physical layer processing processed in a DU of a fronthaul interface. For example, the upper-PHY may include FEC encoding/decoding, scrambling, modulation/demodulation. Hereinafter, a lower-PHY means a physical layer processing processed in an RU of the fronthaul interface. For example, the lower-PHY may include FFT/iFFT, digital beamforming, physical random access channel (PRACH) extraction, and filtering. However, the above-described criteria do not exclude embodiments through other function splits. Functional configurations, signaling, or operations of embodiments, may be applied not only to the third function split 420a or the fourth function split 420b, but also to other function splits.

The embodiments of the disclosure exemplarily describe standards of eCPRI and O-RAN as a fronthaul interface when transmitting a message between a DU (e.g., the DU 210) of FIG. 2A) and an RU (e.g., the RU 220 of FIG. 2A). The Ethernet payload of the message may include an eCPRI header, an O-RAN header, and an additional field. Hereinafter, various embodiments of the disclosure are described using standard terms of eCPRI or O-RAN, but other expressions having equivalent meanings to each term may be used as substitutes in various embodiments of the disclosure. Hereinafter, various embodiments of the disclosure are described using the standard term of eCPRI or O-RAN, but are not limited thereto. For example, in various embodiments of the disclosure, a CPRI standard may be used as a fronthaul interface.

Ethernet and eCPRI, which are easy to share with networks, may be used as a transport protocol of fronthaul. The eCPRI header and the O-RAN header may be included in the Ethernet payload. The eCPRI header may be located at the front of the Ethernet payload. The eCPRI header has the following contents.
1) ecpriVersion (4 bits): This parameter indicates an eCPRI protocol version.
2) ecpriReserved (3 bits): This parameter is reserved for further use of eCPRI.
3) ecpriConcatenation (1 bit): This parameter indicates when eCPRI concatenation is in use.
4) ecpriMessage (1 byte): This parameter indicates a type of a service carried by a message type. For example, the parameter indicates an IQ data message, a real-time control data message, or a transport network delay measurement message.
5) ecpriPayload (2 bytes): This parameter indicates a byte size of a payload portion of the eCPRI message.
6) ecpriRtcid/ecpriPcid (2 bytes): This parameter is an extended Antenna-carrier (eAxC) identifier (eAxC ID) and identifies a specific data flow related to each of C-plane (ecpriRtcid) or U-plane (ecpriPcid) message.
7) ecpriSeqid (2 bytes): This parameter provides unique message identification and order at two levels. The first octet of this parameter is a sequence ID used to identify the order of messages within an eAxC message stream, and the sequence ID is used to ensure that all messages are received and to reorder out-of-order messages. The second octet of this parameter is a subsequence ID. The subsequence ID is used to verify ordering and implement reordering when radio-transport-level (eCPRI or IEEE-1914.3) fragmentation occurs.

The eAxC identifier (ID) includes a band and sector identifier (‘BandSector_ID’), a component carrier identifier (‘CC_ID’), a spatial stream identifier (‘RU_Port_ID’), and a distributed unit identifier (‘DU_Port_ID’). The bit allocation of the eAxC ID may be distinguished as follows.
1) DU_port ID: The DU_port ID is used to distinguish processing units in the O-DU (e.g. different baseband cards). It is expected that the O-DU will allocate bits for the DU_port ID and the O-RU will attach the same value to the UL U-plane message carrying the same sectionId data.
2) BandSector_ID: Aggregated cell identifier (identification of band and sector supported by O-RU).
3) CC_ID: CC_ID identifies carrier components supported by the O-RU.
4) RU_port ID: The RU_port ID designates logical flows such as data layer or spatial streams, and logical flows such as separate numerologies (e.g., PRACH) or signal channels like SRS requiring specific antenna assignments.

An application protocol of the fronthaul may include a control plane (C-plane), a user plane (U-plane), a synchronization plane (S-plane), and a management plane (M-plane).

The control plane may be configured to provide scheduling information and beamforming information via a control message. The control plane means real-time control between the DU and the RU. The user plane may include IQ sample data transmitted between the DU and the RU. The user plane may include downlink data (IQ data or SSB/RS), uplink data (IQ data or SRS/RS), or PRACH data of the user. A weight vector of the beamforming information described above may be multiplied by the user's data. The synchronization plane generally means traffic between the DU and the RU for a synchronization controller (e.g., IEEE grand master). The synchronization plane may be related to timing and synchronization. The management plane means non-real-time control between the DU and the RU. The management plane may be related to initial setup, non-realtime reset or reset, and non-realtime report.

A message in the control plane, that is, the C-plane message, may be encapsulated based on a two-layer header approach. A first layer may be configured with eCPRI common header or the IEEE 1914.3 common header, which includes fields used to indicate a message type. A second layer is an application layer, which includes fields necessary for control and synchronization. In the application layer, a section defines a characteristic of U-plane data transmitted or received on a beam with one pattern ID. The section types supported within the C-plane are as follows.

Section Type may indicate the purpose of the control message transmitted in the control plane. For example, the purposes of Section Type are as follows.
1) sectionType=0: Used to indicate resource blocks or symbols not used in the DL or the UL.
2) sectionType=1: Used for most DL/UL wireless channels. Herein, “most” refers to channels that do not require time or frequency offsets such as those required for mixed numerology channels.
3) sectionType=2: reserved for further use
4) sectionType=3: PRACH and mixed-numerology channels. Channels that require time or frequency offsets or differ from the nominal SCS value(s).
5) sectionType=4: reserved for further use
6) sectionType=5: UE scheduling information. Transmits UE scheduling information so that the RU can perform real-time BF weight calculation (O-RAN optional BF method)
7) sectionType=6: Transmit UE-specific channel information. Periodically transmits UE channel information so that the RU can perform real-time BF weight calculation (O-RAN optional BF method)
8) sectionType=7: Used for LAA support

In the following specification, a network configuration protocol (NETCONF) client (or a client server) (e.g., the DU 210 of FIGS. 2A, 2B, 3A, and 3B) may be configured to manage a NETCONF server (e.g., the RU 220 of FIGS. 2A, 2B, 3A, and 3B). The NETCONF client and the NETCONF server may establish a session for performing an operation for a management plane (M-plane). Hereinafter, an operation of the NETCONF client and the NETCONF server will be described.

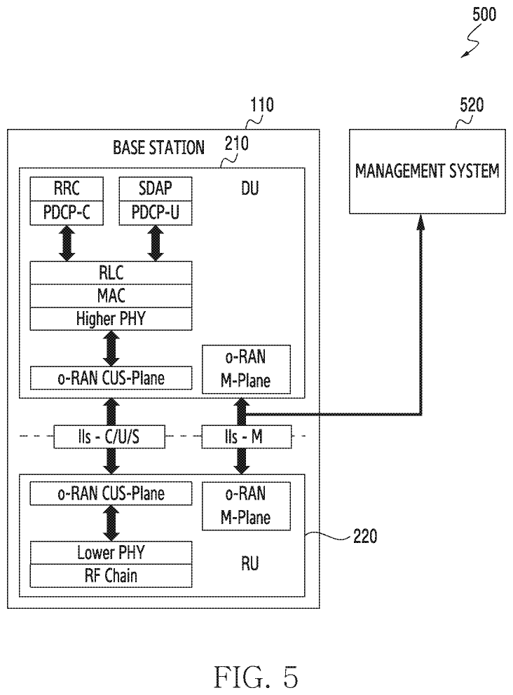

FIG. 5 illustrates an example of an architecture for a function split between a DU and an RU according to an embodiment of the disclosure.

Referring to FIG. 5, an architecture 500 may correspond to the fronthaul interface illustrated in FIG. 2B. The architecture 500 may include a base station 110 and a management system 520. A DU 210 may correspond to the O-DU 251 of FIG. 2B. An RU 220 may correspond to the O-RU 253-1 of FIG. 2B.

For example, an interface lower-layer split M-plane (LLS-M) between the DU 210 and the RU 220 may provide a management plane (M-plane) through an LLS interface. The LLS-M may perform an operation related to initialization, configuration, and management of the RU 220 to support the above-described function split.

For example, the management plane (M-plane) may be configured based on a yet another next generation (YANG) model. Unlike a management information base (MIB) used in an existing simple network management protocol (SNMP), the YANG model used in NETCONF may be in a tree form, and a list may be included in a list. Accordingly, the YANG model may represent a hierarchical relationship. The YANG model may put multiple list values into one command and collectively change them. In a case of putting the multiple lists into one command, in a case that an error occurs while changing a setting with multiple times of commands in order to change a service state, a problem of affecting a service by ceasing in a state in which continuing progress and restoration are impossible may be prevented.

For example, the management system 520 may be included in at least one of the DU 210, a service management and orchestration (SMO), and/or a network management system (NMS). The management system 520 may be configured to manage an operation of the RU 220.

For example, a management plane configured based on the NETCONF and the YANG model may be used to support management characteristics including “start-up” installation, software management, configuration management, performance management, fault management, and file management.

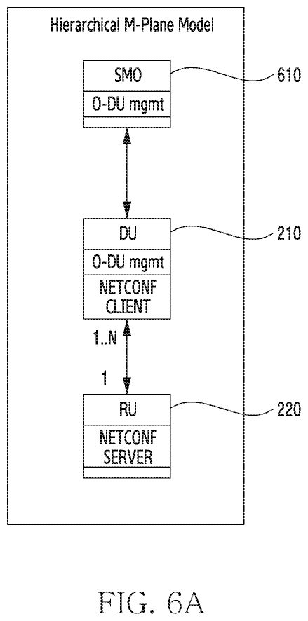

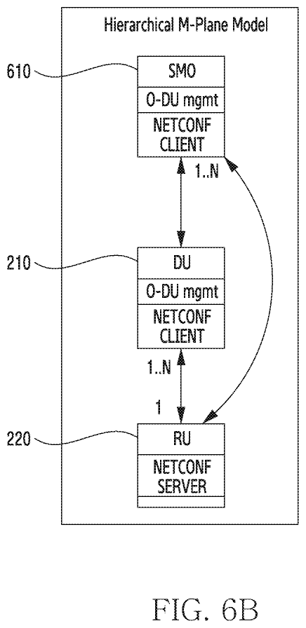

According to an embodiment, the management plane may support two architecture models. The two architecture models will be described below in FIGS. 6A and 6B.

FIG. 6A illustrates an example of a management plane configured based on a hierarchical model according to an embodiment of the disclosure.

FIG. 6B illustrates an example of a management plane configured based on a hybrid model according to an embodiment of the disclosure.

Referring to FIG. 6A, a management plane (M-plane) may be configured based on the hierarchical model. In the management plane configured based on the hierarchical model, an RU 220 may be managed by one or more DUs using a NETCONF-based management plane interface. For example, an interface between an SMO 610 (or NMS) and a DU 210 may be configured. However, an interface between the SMO 610 and the RU 220 may not be configured. The SMO 610 may not directly manage the RU 220. The SMO 610 may be an example of the management system 520 of FIG. 5.

Referring to FIG. 6B, a management plane (M-plane) may be configured based on the hybrid model. In the management plane configured based on the hybrid model, in addition to a logical interface between the DU 210 and the RU 220, one or more direct logical interfaces between the SMO 610 and the RU 220 may be configured. For example, an interface between the SMO 610 (or NMS) and the DU 210 may be configured. In addition, an interface between the SMO 610 and the RU 220 may also be configured. The SMO 610 may directly manage the RU 220.

According to an embodiment, in the management plane configured based on the hybrid model for the RU 220, the RU 220 may have end-to-end internet protocol (IP) hierarchical connectivity with the SMO 610. From a physical network perspective, a connection between the SMO 610 and the RU 220 may be established through the DU 210. The DU 210 may serve as an IP/Ethernet packet forwarder. The DU 210 may forward a packet between the RU 220 and the SMO 610. Direct logical communication between the RU 220 and the SMO 610 may be activated through the RU 220 to which routable IPs or local private IPs resolved by (or implemented by the DU 210) a network address translation (NAT) function in a network are assigned.

Referring to FIGS. 6A and 6B, there may be no explicit signaling indicating that the RU 220 operates based on the hierarchical model or the hybrid model. A NETCONF server may support multiple NETCONF sessions. All RUs may support a hierarchical deployment and a hybrid deployment.

For example, NETCONF may be used as a network element management protocol. YANG may be used as a data modeling language. By using a standardized framework and a common modeling language, integration between the DU 210 and the RU 220, as well as operator network integration in a case of an element sharing a common set of capabilities, may be simplified. The framework may support integration of products having differing capabilities by a disclosed data model. NETCONF may support an architecture based on the hybrid model so that a plurality of clients may subscribe to and receive information generated in the NETCONF server.

According to an embodiment, based on a transport topology, various modes of a network connection may be established between the DU 210, the RU 220, and the SMO 610. A basic requirement for the management plane may be to have an end-to-end IP connection between the RU 220 and elements for managing the RU 220. The elements for managing the RU 220 may include the DU 210 or the SMO 610. The elements for managing the RU 220 may be referred to as RU controllers. The RU 220 may support IPv4 or IPv6, and optionally support a dual stack (IPv4 and IPv6).

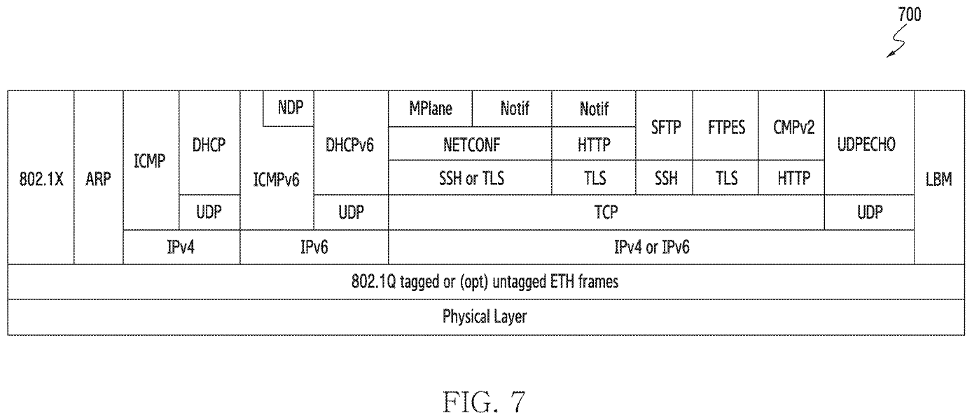

FIG. 7 illustrates examples of management plane interfaces according to an embodiment of the disclosure.

Referring to FIG. 7, a management plane interface may be defined between an RU controller and an RU 220. A protocol stack 700 of the management plane interface may be illustrated in FIG. 7.

For example, according to the protocol stack 700, a first layer may be configured as a physical layer. A second layer may be configured as an Ethernet MAC layer. A third layer may be configured as an IP layer based on IPv4 or IPv6. A fourth layer may be configured as a TCP layer. A security layer may be configured as an SSH layer or a TLS layer.

For example, a transmission network layer built based on IP transport, secure shell/transmission control protocol (SSH/TCP), and transport layer security (TLS) may be used to deliver a management plane message between the RU controller (e.g., a DU 210 or an SMO 610) and the RU 220. According to an embodiment, the RU 220 may support a function for supporting an asynchronous notification transmitted using hypertext transfer protocol over secure socket layer (HTTPS). When the RU controller corresponds to the SMO 610 operating as a non-persistent NETCONF session for the RU 220, the function may activate system optimization.

According to an embodiment, the management plane may provide various functions to the RU 220. The functions provided by the management plane may be implemented using functions provided by NETCONF.

For example, the management plane may provide a “start up” installation function. While “start up” is performed, the RU 220 may obtain network layer parameters statically or dynamically through dynamic host configuration protocol (DHCP) or DHCP version 6 (DHCPv6). While “start up” is performed, the RU 220 may obtain an IP address of at least one RU controller (e.g., the DU 210 or the SMO 610), and the RU 220 may establish a NETCONF connection using a “call home” function. In a case that the RU 220 operates in an environment in which the SMO 610 is included, the RU 220 may obtain an IP address of an event controller, and the RU 220 may perform “pnfRegistration” triggering the SMO 610 to establish the NETCONF connection using information recovered in a “pnfRegistration” procedure.

For example, the management plane may provide a software management function when there is a request from the RU controller (e.g., the DU 210 or the SMO 610). The management plane may be used for download, installation, verification, and activation of new software. Software download may be triggered by NETCONF remote procedure call (RPC) operations. Actual software download may be performed using SSH file transfer protocol (sFTP) through SSH (sFTP with SSH) or file transfer protocol explicit-mode secure (FTPES) through TLS (FTPES with TLS).

For example, the management plane may provide a configuration management function. Configuration management may include various scenarios such as retrieving resource state, modifying resource state, modifying parameters, and retrieving parameters. NETCONF “get-config” and “edit-config” RPCs may be used for retrieving and updating configuration parameters in the RU 220.

For example, the management plane may perform performance management. The performance management may include measurements and counters used to collect data regarding operations of the RU 220. The performance management may be performed to optimize an operation of the RU 220. A measurement result may be reported by two options. The measurement result may be reported by a YANG notification or a file upload. As an example, for reporting through the YANG notification, a statistics definition of a YANG model may be used per measurement group. As an example, the measurement result may be reported based on a file upload procedure. The measurement result may be periodically stored in a data file.

For example, the management plane may perform fault management. The fault management may be used to transmit an alarm notification to a NETCONF client. Through the fault management, the alarm notification (or an alarm subscription) may be activated or deactivated.

For example, the management plane may perform file management. Through the file management, the RU controller (e.g., the DU 210 or the SMO 610) may upload a file stored in the RU 220 to the RU controller by triggering the RU 220. The RU 220 may provide various types of files, and retrieved files may be used for various purposes. Simultaneous multiple file upload operations may be supported in the same SFTP or FTPES connection between the RU 220 and the DU 210/SMO 610.

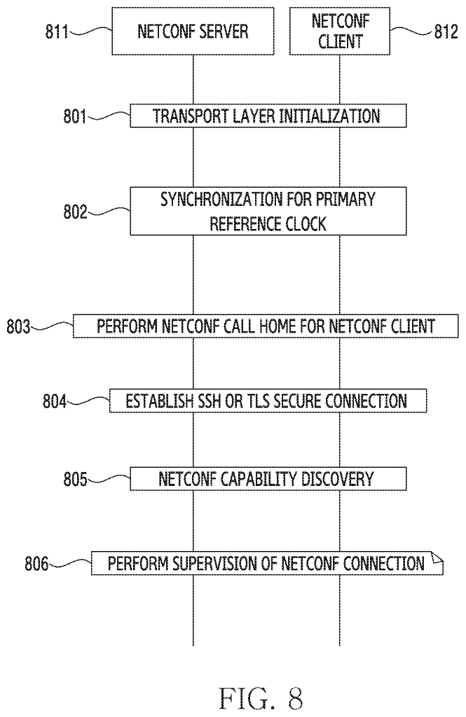

FIG. 8 illustrates an example of an operation related to “start up” installation according to an embodiment of the disclosure.

Referring to FIG. 8, a NETCONF server 811 and a NETCONF client 812 may perform operations related to “start up” installation. Operations 801 to 806 may represent operations related to supervision of a NETCONF connection among operations related to “start up” installation. The NETCONF server 811 may include an RU 220. The NETCONF client 812 may include a DU 210 and/or an SMO 610. The NETCONF server 811 may be referred to as the RU 220. The NETCONF client 812 may be referred to as the DU 210 and/or the SMO 610.

In operation 801, the NETCONF server 811 and the NETCONF client 812 may perform transport layer initialization. For example, the NETCONF server 811 may perform a management plane transport layer resolution (e.g., DHCP, MAC, VLAN, or IP) operation. The NETCONF server 811 may recover an IP address of the NETCONF client 812 and/or a pnfRegistration event-collector.

In operation 802, the NETCONF server 811 may perform synchronization of the NETCONF server 811 for a primary reference clock. According to an embodiment, operation 802 may also be performed simultaneously with operation 801.

In operation 803, the NETCONF server 811 may perform “NETCONF call home” for discovering the NETCONF client 812. For example, the NETCONF server 811 may transmit “NETCONF call home” to the NETCONF client 812.

In operation 804, the NETCONF client 812 may perform SSH or TLS connection establishment. For example, the NETCONF client 812 may establish an SSH session or TLS session connection with the NETCONF server 811.

In operation 805, the NETCONF server 811 and the NETCONF client 812 may perform NETCONF capability discovery.

In operation 806, the NETCONF server 811 and the NETCONF client 812 may perform supervision of the NETCONF connection.

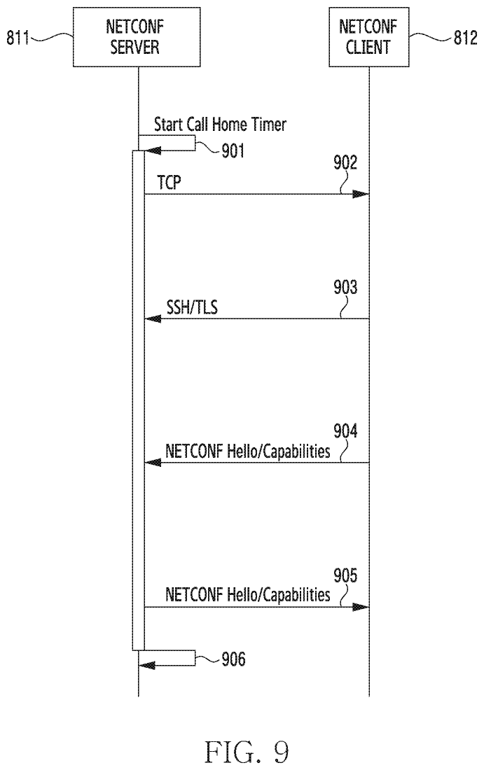

FIG. 9 illustrates an example of an operation related to “call home” according to an embodiment of the disclosure.

Referring to FIG. 9, in operation 901, a NETCONF server 811 (e.g., an RU 220) may start a call home timer.

In operation 902, the NETCONF server 811 may start a TCP connection to a NETCONF client 812. When performing call home for NETCONF clients in a “client-info” container, the NETCONF server 811 may use a signaled port or a manually configured port. When performing call home for NETCONF clients in a “configured-client-info” container, the NETCONF server 811 (e.g., the RU 220) may use a port configured by another NETCONF client. In a case that a port is not signaled, is not manually configured in the “client-info” container, or is not configured in the “configured-client-info” container, the NETCONF server 811 may use a port configured in “call-home-ssh-port” to represent that the NETCONF server 811 protects the NETCONF connection using SSHv2. The NETCONF server 811 may use a port configured in “call-home-tls-port” to represent that the NETCONF server 811 protects the NETCONF connection using TLS.

For example, in a case that “call-home-ssh-port” does not exist, the NETCONF server 811 may use a port 4334 to represent that the NETCONF server 811 protects the NETCONF connection using SSHv2. In a case that “call-home-tls-port” does not exist, the NETCONF server 811 may use a port 4334 to represent that the NETCONF server 811 protects the NETCONF connection using TLS.

In operation 903, when the NETCONF client 812 accepts the TCP connection at the assigned port, the NETCONF client 812 may start an SSH session and/or a TLS connection.

In operation 904 and operation 905, the NETCONF client 812 may start a NETCONF session connection using the SSH session and/or the TLS connection. For example, the NETCONF client 812 may transmit, to the NETCONF server 811, a hello message including information on a capability of the NETCONF client 812. The NETCONF server 811 may transmit, to the NETCONF client 812, a hello message including information on a capability of the NETCONF server 811.

In operation 906, the NETCONF server 811 may terminate the call home timer.

Based on operations 901 to 906, operations related to call home may be performed. The NETCONF server 811 and the NETCONF client 812 may establish the NETCONF session connection based on the operations related to call home.

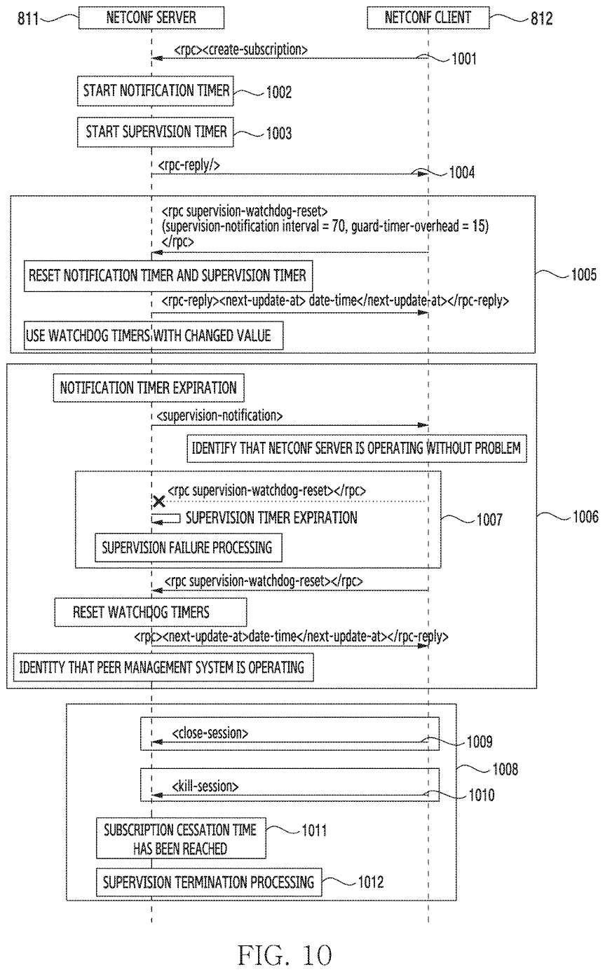

FIG. 10 illustrates an example of an operation for monitoring a NETCONF connection according to an embodiment of the disclosure.

Referring to FIG. 10, when a NETCONF server 811 (e.g., an RU 220) has a session with a NETCONF client 812 (e.g., a DU 210 or an SMO 610) subscribed to receive “supervision-notification”, the NETCONF server 811 may operate watchdog timers (e.g., a supervision timer and a notification timer) to check whether a session for the NETCONF client 812 is maintained. The NETCONF server 811 may provide a NETCONF notification to notify a remote system that a management system is operating.

In a case of the NETCONF server 811 supporting a “SUPERVISION-WITH-SESSION-ID” function, a “supervision-notification” message may indicate a NETCONF session ID related to subscription of an event notification. When subscribing to receive a supervision notification, the NETCONF client 812 may use its session ID in subscription filter criteria for indicating, to the NETCONF server 811, “supervision-notification” events to be delivered by the NETCONF server 811 to the NETCONF client 812. The session ID may be provided by the NETCONF server 811 to the NETCONF client 812 in an initial Hello message exchange.

The NETCONF client 812 (e.g., an RU controller, the DU 210, or the SMO 610) that has subscribed to “supervision-notification” may notify the NETCONF server 811 that the NETCONF client 812 is operating by using a <supervision-watchdog-reset> RPC.

The NETCONF server 811 may support an operation of individual supervision watchdog timers for each NETCONF client that has subscribed to “supervision-notification”.

The authorized NETCONF client 812 may activate an operation of the watchdog timers by generating a “supervision-notification” subscription. When the operation of the watchdog timers is activated, a timer may be regarded as running.

The NETCONF server 811 (e.g., the RU 220) may support bidirectional monitoring of the NETCONF connection using two timers referred to as the watchdog timers. For example, the two timers may include the notification timer and the supervision timer.

A value of the notification timer may be set to a value corresponding to “supervision-notification-interval”. A default value of the notification timer may be set to 60 seconds. The NETCONF server 811 may transmit “supervision-notification” to the NETCONF client 812 that has subscribed to receive “supervision-notification”. The NET CONF server 811 may transmit “supervision-notification” based on the notification timer being expired. The NETCONF client 812 (or the RU controller, the DU 210, or the SMO 610) may identify whether the NETCONF connection to the NETCONF server 811 is operating, based on the received “supervision-notification”.

A value of the supervision timer may be set to a sum of a value corresponding to “supervision-notification-interval” and “guard-timer-overhead”. A default value of “supervision-notification-interval” may be set to 60 seconds. A default value of “guard-timer-overhead” may be set to 10 seconds. The NETCONF server 811 may identify a supervision failure operation based on the supervision timer being expired. To prevent the expiration of the supervision timer, the NETCONF client 812 that has subscribed to receive “supervision-notification” may repeatedly reset the supervision timer. The resetting of the supervision timer may be regarded, in the NETCONF server 811, as a confirmation that the NETCONF connection with the NETCONF client 812 is operating.

In operation 1001, the NETCONF client 812 may subscribe to receive “supervision-notification”. The NETCONF client 812 may transmit, to the NETCONF server 811, a message for generating a subscription.

In operation 1002, the NETCONF server 811 may start the notification timer set to the default value.

In operation 1003, it may start the supervision timer set to the default value.

In operation 1004, the NETCONF server 811 may transmit, to the NETCONF client 812, a message for confirming the subscription.

Operation 1005, operation 1006, and operation 1008 may be related to an operation for supervision.

Operation 1005 may be related to an operation for changing a default value of a timer. The NETCONF client 812 may transmit, to the NETCONF server 811, a message for resetting the watchdog timers. The message may include information for setting “supervision-notification-interval” and information for setting “guard-timer-overhead”. The NETCONF server 811 may reset the notification timer and the supervision timer for the NETCONF session. The NETCONF server 811 may reset the notification timer and the supervision timer based on the information for setting “supervision-notification-interval” and the information for setting “guard-timer-overhead”. The NETCONF server 811 may transmit, to the NETCONF client 812, a message indicating that the notification timer and the supervision timer have been reset. The NETCONF server 811 may use the watchdog timers set to a changed value.

Operation 1006 may be related to an operation for transmitting a supervision message. For example, the NETCONF server 811 may identify that the notification timer has expired. The NETCONF server 811 may transmit “supervision-notification” to the NETCONF client 812. “supervision-notification” may be transmitted to indicate that the NETCONF server 811 is operating without a problem.

The NETCONF client 812 may identify (or confirm) that the management system of the NETCONF server 811 is operating. The NETCONF client 812 may identify (or confirm) that the NETCONF server 811 is operating without a problem. The NETCONF client 812 may transmit, to the NETCONF server 811, a message for resetting the watchdog timers. The NETCONF server 811 may reset the watchdog timers for the NETCONF session. The NETCONF server 811 may transmit, to the NETCONF client 812, a message indicating that the notification timer and the supervision timer have been reset. The NETCONF server 811 may identify (or confirm) that a peer management system is operating. According to an embodiment, in a case that the supervision timer expires, operation 1007 may be performed. The NETCONF server 811 may fail to receive the message for resetting the watchdog timers transmitted by the NETCONF client 812, and the supervision timer may be expired. The NETCONF server 811 may process a supervision failure.

Operation 1008 may be related to an operation for terminating a supervision procedure by the NETCONF client 812.

In a case of closing the NETCONF session, operation 1009 may be performed. In operation 1009, the NETCONF client 812 may transmit, to the NETCONF server 811, a message for closing the NETCONF session.

In a case of killing the NETCONF session, operation 1010 may be performed. In operation 1010, the NETCONF client 812 may transmit, to the NETCONF server 811, a message for killing the NETCONF session.

In a case that a subscription cessation time has been reached, operation 1011 may be performed. In operation 1011, the NETCONF server 811 may identify that the subscription cessation time has been reached.

After one of operations 1009 to 1011 is performed, in operation 1012, the NETCONF server 811 may process supervision termination.

When supervision for the NETCONF session is executed, the NETCONF server 811 may monitor the NETCONF session through the above-described operations 1001 to 1011.

According to an embodiment, the NETCONF client 812 may set (or change) connection information for establishing a session. For example, the NETCONF client 812 may establish a session with the NETCONF server 811 by using connection information of the NETCONF client 812 (or connection information stored in memory of the NETCONF client). In a case that the connection information of the NETCONF client 812 and the connection information of the NETCONF server 811 are identical, the session may be established. According to an embodiment, the NETCONF client 812 may change the connection information of the NETCONF client 812 and transmit, to the NETCONF server, a message for changing the connection information of the NETCONF server 811. Hereinafter, in a case that a reset process is performed in the NETCONF server 811 after the connection information of the NETCONF server 811 is changed, an example of operations of the NETCONF client 812 and the NETCONF server 811 for establishing a session will be described.

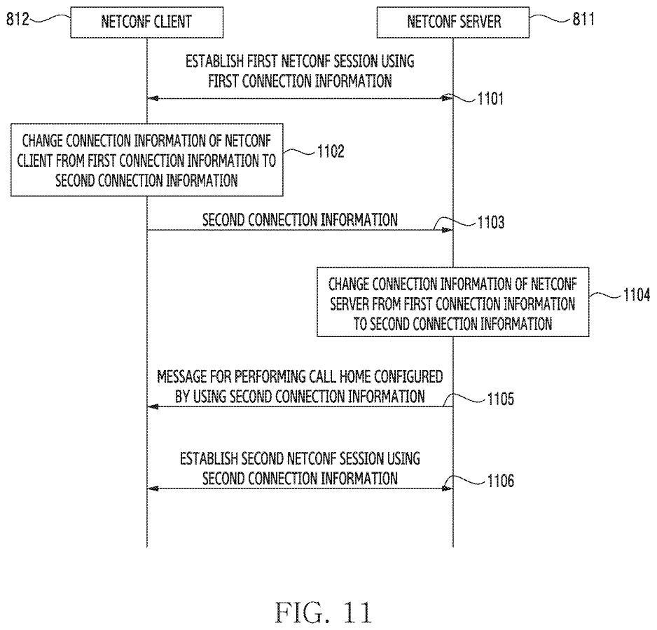

FIG. 11 illustrates an example of an operation of a NETCONF client and a NETCONF server for establishing a session in a case that connection information is changed according to an embodiment of the disclosure.

Referring to FIG. 11, in operation 1101, a NETCONF server 811 and a NETCONF client 812 may establish a first NETCONF session using first connection information. For example, the first connection information may be basically set in the NETCONF server 811 and the NETCONF client 812. As an example, in a case that the NETCONF server 811 is first connected to the NETCONF client 812, the NETCONF server 811 and the NETCONF client 812 may establish the first NETCONF session by using the first connection information.

According to an embodiment, the NETCONF server 811 may store connection information for establishing a session. Connection information stored in the NETCONF server 811 may be referred to as connection information of the NETCONF server 811. The NETCONF client 812 may store connection information for establishing a session. Connection information stored in the NETCONF client 812 may be referred to as Connection information of the NETCONF client 812.

For example, the connection information of the NETCONF server 811 may be set to the first connection information. The connection information of the NETCONF client 812 may be set to the first connection information. In a case that the connection information of the NETCONF server 811 and the connection information of the NETCONF client 812 are set to be identical, a session between the NETCONF server 811 and the NETCONF client 812 may be established. As an example, the NETCONF server 811 may transmit, to the NETCONF client 812, a message for performing ‘call home’ configured using the first connection information. The NETCONF server 811 may request session establishment from the NETCONF client 812 by using the message. According to an embodiment, the NETCONF client 812 may transmit, to the NETCONF server 811, a message for performing ‘call home’ configured using the first connection information. The NETCONF client 812 may request session establishment from the NETCONF server 811 by using the message.

The NETCONF client 812 and the NETCONF server 811 may establish the first NETCONF session by using the message (or the first connection information) for performing ‘call home’ configured by using the first connection information.

In operation 1102, the NETCONF client 812 may change the connection information of the NETCONF client 812 from the first connection information to second connection information. For example, while the first NETCONF session is established, the NETCONF client 812 may change the connection information of the NETCONF client 812 from the first connection information to the second connection information.

For example, to change a connection setting for the NETCONF session, the NETCONF client 812 may change the connection information of the NETCONF client 812 from the first connection information to the second connection information.

In operation 1103, the NETCONF client 812 may transmit, to the NETCONF server 811, the second connection information to change the connection information of the NETCONF server 811 from the first connection information to the second connection information. For example, the NETCONF server 811 may receive the second connection information from the NETCONF client 812.

In operation 1104, the NETCONF server 811 may change, in response to receiving the second connection information, the connection information of the NETCONF server 811 from the first connection information to the second connection information.

For example, based on the connection information of the NETCONF server 811 being changed (or set) to the second connection information, the first NETCONF session may be terminated. For example, after the connection information of the NETCONF server 811 is changed, the NETCONF server 811 may deactivate the first connection information. The NETCONF server 811 may activate only the second connection information.

In operation 1105, the NETCONF server 811 may transmit, to the NETCONF client 812, a message for performing ‘call home’ configured by using the second connection information. Since the connection information of the NETCONF server 811 has been set to the second connection information, the NETCONF server 811 may configure the message for performing ‘call home’ by using the second connection information. The NETCONF server 811 may transmit, to the NETCONF client 812, the message for performing ‘call home’ to establish a second NETCONF session.

In operation 1106, the NETCONF server 811 and the NETCONF client 812 may establish the second NETCONF session using the second connection information. For example, the NETCONF client 812 and the NETCONF server 811 may establish the second NETCONF session by using the message (or the second connection information) for performing ‘call home’ configured by using the second connection information.

According to an embodiment, the first connection information and the second connection information may be related to at least one of information on a user account of the NETCONF client 812 and the NETCONF server 811, information on a secure shell (SSH) port for ‘call home’, information on an SSH server port, information on a transport layer security (TLS) port for ‘call home’, or information on a TLS server port.

For example, the information on the user account of the NETCONF client 812 and the NETCONF server 811 may be configured as shown in Tables 1 and 2 below.

```
TABLE 1
grouping user-list {
  description “a user list grouping”;
  list user {
    key “name”;
    description
      “The list of local users configured on this device.”;
    leaf name {
      type nacm:user-name-type;
      description
        “The user name string identifying this entry.
        NOTE: o-ran-usermgmt:user-profile/user/name is
        identical to nacm:nacm/groups/group/user-name
        but the current schema is preserved for backwards
        compatibility.”;
    }
    leaf account-type {
      type enumeration {
        enum PASSWORD {
          description “the user-name is for password based authentication”;
        }
        enum CERTIFICATE {
          description “the user-name is for certificate based authentication”,
        }
      }
      default “PASSWORD”;
      description “the account type”;
    }
    leaf password {
      nacm:default-deny-all;
      type password-type;
      description
        “The password for this entry.
        This field is only valid when account-type is NOT set to CERTIFICATE,
        i.e., when account-type is NOT present or present and set to
        PASSWORD.”;
    }
```

```
TABLE 2
leaf enabled {
        type boolean;
        description
          “Indicates whether an account is enabled or disabled.
            A NETCONF Server shall reject a configuration that attempts to
            enable a Password account for an account where the password leaf
            is not configured.
            This validation statement is included in the YANG description and
            not in a MUST statement to preserve backwards compatibility.”;
      }
      leaf-list sro-id {
        if-feature feat:SHARED-ORU-MULTI-OPERATOR;
        type string;
        description
          “An optional list if Shared Resource Operator identities associated with the
          user-account. Used to realize enhanced access privileges in a shared O-RU.
          When an sro-id is configured in the O-RU, the O-RU shall
          implement additional sro-id based NETCONF access control
          as specified in O-RAN.WG4.MP.0-v10.00.
          The O-RU does not further interpret the specific value of sro-id.”;
      }
    }
  }
```

Referring to Tables 1 and 2, the information on the user account of the NETCONF client 812 and the NETCONF server 811 may include information on an account name, information on an account type, information on an account password, information on whether an account is activated, and/or information on whether the NETCONF server 811 (e.g., an RU 220) is connected to a plurality of NETCONF clients.

For example, the first connection information may be information basically set in the NETCONF client 812 and the NETCONF server 811. The second connection information may be information changed in the NETCONF client 812.

As an example, in a case that an initial system is initialized, an account name for an account type of PASSWORD may be set to ‘oranuser’. The first connection information may include information on the account name set to ‘oranuser’. In a case that the initial system is initialized, a password for the account type of PASSWORD may be ‘o-ran-password’. The first connection information may include information on the account password set to ‘o-ran-password’. The above-described example is exemplary, and the first connection information may be changed according to the NETCONF client 812 and the NETCONF server 811.

For example, the information on the SSH port for ‘call home’ and the information on the SSH server port may be configured as shown in Table 3 below.

TABLE 3

```
container m-plane-ssh-ports {
    description “leafs for managing SSH ports”;
    leaf call-home-ssh-port {
      type inet:port-number;
      default 4334;
      description “The configured call home server port number”;
    }
    leaf server-ssh-port {
      type inet:port-number;
      default 830;
      description “The configured SSH server port number”;
    }
  }
```

Referring to Table 3, the information on the SSH port for ‘call home’ (‘call-home-ssh-port’) may include information on a default port of the SSH port for ‘call home’. A port 4334 may be set as the default port of the SSH port for ‘call home’. The first connection information may include information on the default port of the SSH port for ‘call home’, which is set to the port 4334. The information on the SSH server port (‘server-ssh-port’) may include information on a default port of the SSH server port. A port 830 may be set as the default port of the SSH server port. The first connection information may include information on the default port of the SSH server port, which is set to the port 830.

For example, the information on the transport layer security (TLS) port for ‘call home’ and the information on the TLS server port may be configured as shown in Table 4 below.

```
TABLE 4
container m-plane-tls-ports {
      description “leafs for managing TLS ports”;
      leaf call-home-tls-port {
        type inet:port-number;
        default 4335;
        description “The configured call home server port number”;
      }
      leaf server-tls-port {
        type inet:port-number;
        default 6513;
        description “The configured TLS server port number”;
      }
    }
  }
```

Referring to Table 4, the information on the TLS port for ‘call home’ (‘call-home-tls-port’) may include information on a default port of the TLS port for ‘call home’. A port 4335 may be set as the default port of the TLS port for ‘call home’. The first connection information may include information on the default port of the TLS port for ‘call home’, which is set to the port 4335. The information on the TLS server port (‘server-tls-port’) may include information on a default port of the TLS server port. A port 6513 may be set as the default port of the TLS server port. The first connection information may include information on the default port of the TLS server port, which is set to the port 6513.

According to an embodiment, the NETCONF client 812 may change the connection information of the NETCONF client 812 and the connection information of the NETCONF server 811. The NETCONF client 812 may change the connection information of the NETCONF server 811 through the first NETCONF session and close the first NETCONF session. The NETCONF client 812 and the NETCONF server 811 may establish the second NETCONF session by using the changed connection information (i.e., the second connection information).

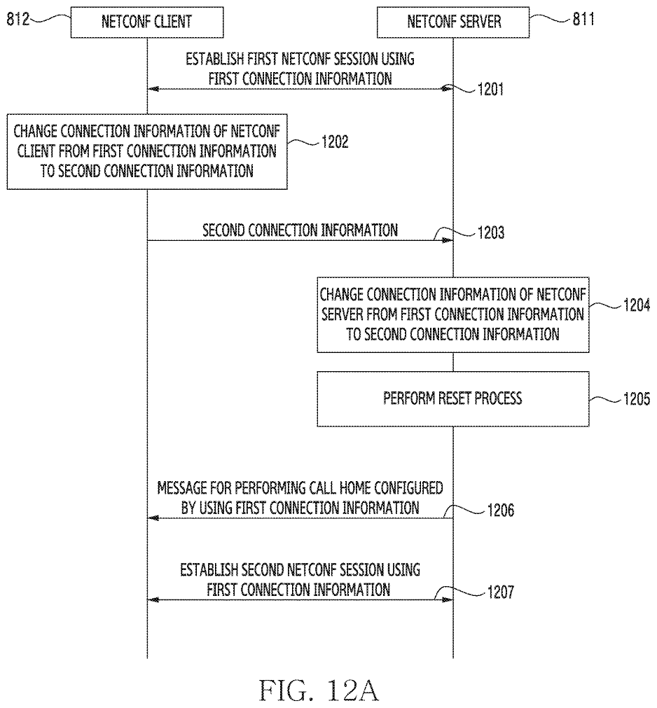

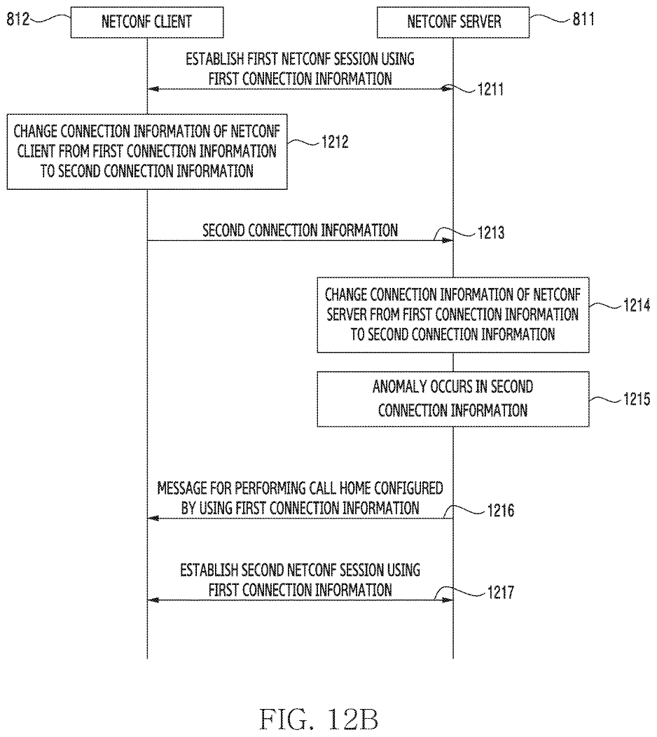

FIG. 12A illustrates an example of an operation of a NETCONF client and a NETCONF server in a case that a reset process is performed in the NETCONF server after connection information is changed according to an embodiment of the disclosure.

Referring to FIG. 12A, in operation 1201, a NETCONF server 811 and a NETCONF client 812 may establish a first NETCONF session by using first connection information. For example, the first connection information may be basically set in the NETCONF server 811 and the NETCONF client 812. As an example, in a case that the NETCONF server 811 is first connected to the NETCONF client 812, the NETCONF server 811 and the NETCONF client 812 may establish the first NETCONF session by using the first connection information. Operation 1201 may correspond to operation 1101 of FIG. 11.

In operation 1202, the NETCONF client 812 may change connection information of the NETCONF client 812 from the first connection information to second connection information. Operation 1202 may correspond to operation 1102 of FIG. 11.

In operation 1203, the NETCONF client 812 may transmit, to the NETCONF server 811, the second connection information to change the connection information of the NETCONF server 811 from the first connection information to the second connection information. Operation 1203 may correspond to operation 1103 of FIG. 11.

In operation 1204, the NETCONF server 811 may change, in response to receiving the second connection information, the connection information of the NETCONF server 811 from the first connection information to the second connection information. Operation 1204 may correspond to operation 1104 of FIG. 11.

In operation 1205, the NETCONF server 811 may perform a reset process. For example, the reset process may mean a process for initializing setting information of the NETCONF server 811.

According to an embodiment, the NETCONF client 812 may indicate the NETCONF server 811 to perform the reset process. For example, the NETCONF client 812 may transmit a message for indicating to perform the reset process to the NETCONF server 811. The NETCONF server 811 may perform the reset process based on the received message. In a case that the NETCONF server 811 performs the reset process through the message received from the NETCONF client 812, the NETCONF client 812 may identify that the reset process is performed in the NETCONF server 811.

According to an embodiment, the NETCONF server 811 may identify an anomaly of the NETCONF server 811. The NETCONF server 811 may perform the reset process based on the anomaly of the NETCONF server 811. In a case that the NETCONF server 811 identifies the anomaly, the NETCONF server 811 may perform the reset process by itself. In a case that the NETCONF server 811 performs the reset process by itself, the NETCONF client 812 may fail to identify that the reset process is performed in the NETCONF server 811.

According to an embodiment, the NETCONF server 811 may initialize the connection information of the NETCONF server 811 based on performing the reset process. The NETCONF server 811 may deactivate the second connection information. The NETCONF server 811 may set the connection information of the NETCONF server 811 to the first connection information. For example, the first connection information may be stored in persistent memory of the NETCONF server 811. The NETCONF server 811 may set the connection information of the NETCONF server 811 by using the first connection information stored in the persistent memory of the NETCONF server 811 based on performing the reset process.

In operation 1206, the NETCONF server 811 may transmit, to the NETCONF client 812, a message for performing call home configured by using the first connection information. For example, the NETCONF server 811 may transmit, to the NETCONF client 812, the message for performing call home to establish a second NETCONF session with the NETCONF client 812. Since the connection information of the NETCONF server 811 has been set to the first connection information, the NETCONF server 811 may configure the message for performing call home by using the first connection information.

The NETCONF client 812 may receive the message for performing call home configured by using the first connection information. Although the connection information of the NETCONF client 812 has been set to the second connection information, the NETCONF client 812 may support the first connection information. Therefore, even in a case that the connection information of the NETCONF client 812 is set to the second connection information, in a case that the connection information of the NETCONF server 811 is changed to the first connection information according to the reset process, the NETCONF client 812 may perform a call home procedure with the NETCONF server 811 by using the first connection information.

In operation 1207, in a case that the reset process is performed in the NETCONF server 811, the NETCONF server 811 and the NETCONF client 812 may establish the second NETCONF session using the first connection information. For example, in a case that the reset process is performed in the NETCONF server 811, the connection information of the NETCONF server 811 may be set to the first connection information. The NETCONF server 811 and the NETCONF client 812 may establish the second NETCONF session using the first connection information. For example, the NETCONF client 812 and the NETCONF server 811 may establish the second NETCONF session by using the message (or the first connection information) for performing ‘call home’ configured by using the first connection information.

FIG. 12B illustrates an example of an operation of a NETCONF client and a NETCONF server in a case that an anomaly occurs in second connection information in the NETCONF server after connection information is changed according to an embodiment of the disclosure.

Referring to FIG. 12B, in operation 1211, a NETCONF server 811 and a NETCONF client 812 may establish a first NETCONF session by using first connection information. For example, operation 1211 may correspond to operation 1201 of FIG. 12A.

In operation 1212, the NETCONF client 812 may change connection information of the NETCONF client 812 from the first connection information to second connection information. Operation 1212 may correspond to operation 1202 of FIG. 12A.

In operation 1213, the NETCONF client 812 may transmit, to the NETCONF server 811, the second connection information to change connection information of the NETCONF server 811 from the first connection information to the second connection information. Operation 1213 may correspond to operation 1203 of FIG. 12A.

In operation 1214, the NETCONF server 811 may change, in response to receiving the second connection information, the connection information of the NETCONF server 811 from the first connection information to the second connection information. Operation 1214 may correspond to operation 1204 of FIG. 12A.

In operation 1215, the NETCONF server 811 may identify that an anomaly occurs in the second connection information. For example, the NETCONF server 811 may identify that loss of the second connection information occurs. For example, the NETCONF server 811 may identify that call home is not performed using the second connection information. For example, according to an error of the NETCONF server 811, the loss of the second connection information may occur. The NETCONF server 811 may identify that the anomaly occurs in the second connection information based on the loss of the second connection information occurring. For example, the NETCONF server 811 may fail to use the second connection information. The NETCONF server 811 may identify that the anomaly occurs in the second connection information based on failing to use the second connection information. For example, a bug may occur in the NETCONF server 811. The NETCONF server 811 may initialize a portion of functions of the NETCONF server 811 due to the bug. As the NETCONF server 811 initializes the portion of functions of the NETCONF server 811, the anomaly of the second connection information may occur.

In operation 1216, the NETCONF server 811 may transmit, to the NETCONF client 812, a message for performing call home configured by using the first connection information. Since the anomaly has occurred in the second connection information, the NETCONF server 811 may fail to configure the message for performing call home by using the second connection information. Therefore, the NETCONF server 811 may transmit, to the NETCONF client 812, the message for performing call home configured by using the first connection information. Operation 1216 may correspond to operation 1206 of FIG. 12A.

In operation 1217, in a case that the reset process is performed in the NETCONF server 811, the NETCONF server 811 and the NETCONF client 812 may establish the second NETCONF session using the first connection information. Operation 1217 may correspond to operation 1207 of FIG. 12A.

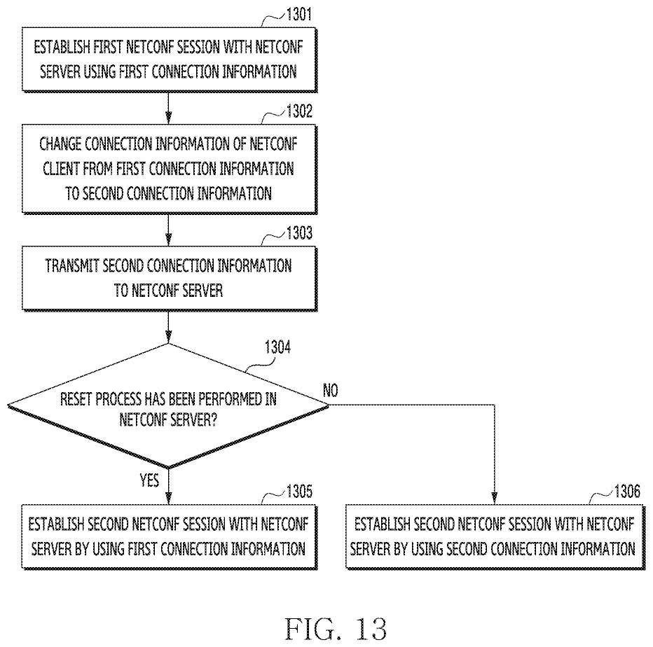

FIG. 13 is a flowchart related to an operation of a NETCONF client in a case that connection information is changed according to an embodiment of the disclosure.

Referring to FIG. 13, in operation 1301, a NETCONF client 812 may establish a first NETCONF session with a NETCONF server 811 by using first connection information.

For example, connection information of the NETCONF client 812 may be set to the first connection information. The first connection information may be default connection information of the NETCONF client 812. Connection information of the NETCONF server 811 may also be set to the first connection information. The first connection information may be default connection information of the NETCONF server 811. In a case that the connection information of the NETCONF client 812 and the connection information of the NETCONF server 811 are identically set to the first connection information, the NETCONF client 812 and the NETCONF server 811 may establish the first NETCONF session by using the first connection information.

For example, the first connection information may be related to at least one of information on a user account of the NETCONF client 812 and the NETCONF server 811, information on a secure shell (SSH) port for ‘call home’, information on an SSH server port, information on a transport layer security (TLS) port for ‘call home’, or information on a TLS server port. As an example, the first connection information may be set according to at least one of Tables 1 to 4.

In operation 1302, the NETCONF client 812 may change the connection information of the NETCONF client 812 from the first connection information to second connection information.

For example, the second connection information may be related to at least one of information on a user account of the NETCONF client 812 and the NETCONF server 811, information on a secure shell (SSH) port for ‘call home’, information on an SSH server port, information on a transport layer security (TLS) port for ‘call home’, or information on a TLS server port. As an example, the second connection information may be managed in the NETCONF client 812.

For example, the NETCONF client 812 may change a name of the user account. For example, the NETCONF client 812 may change a password of the user account. The NETCONF client 812 may change the SSH port for ‘call home’. The NETCONF client 812 may change the SSH server port. The NETCONF client 812 may change the TLS port for ‘call home’. The NETCONF client 812 may change the TLS server port.

In operation 1303, the NETCONF client 812 may transmit the second connection information to the NETCONF server 811. For example, the NETCONF client 812 may transmit the second connection information to the NETCONF server 811 through the first NETCONF session. Since the NETCONF client 812 manages the NETCONF server 811, it may transmit the second connection information to the NETCONF server 811 to change the connection information of the NETCONF server 811. The NETCONF client 812 may transmit the second connection information to the NETCONF server 811 so as to establish a session with the NETCONF server 811 by using the second connection information.

According to an embodiment, based on the second connection information being transmitted, the NETCONF client 812 may close the first NETCONF session. The NETCONF client 812 may close the first NETCONF session based on the connection information of the NETCONF client 812 being changed.

In operation 1304, the NETCONF client 812 may identify whether a reset process has been performed in the NETCONF server 811. For example, after the second connection information is transmitted, the NETCONF server 811 may perform the reset process. The reset process may be performed according to an indication of the NETCONF client 812 or may be performed according to an anomaly of the NETCONF server 811. In a case that the reset process is performed in the NETCONF server 811, the connection information of the NETCONF server 811 may be set to the first connection information. The first connection information may be stored in persistent memory of the NETCONF server 811. In a case that the reset process is performed in the NETCONF server 811, the first connection information may be set to the connection information of the NETCONF server 811.

In operation 1305, in a case that the reset process is performed in the NETCONF server 811, the NETCONF client 812 may establish a second NETCONF session with the NETCONF server 811 by using the first connection information.

For example, in a case that the reset process is performed in the NETCONF server 811, the NETCONF client 812 may receive, from the NETCONF server 811, a message for call home configured by using the first connection information. The NETCONF client 812 may establish the second NETCONF session based on the received message.

For example, in a case that the reset process is performed in the NETCONF server 811, the NETCONF client 812 may transmit, to the NETCONF server 811, the message for ‘call home’ configured by using the first connection information. The NETCONF client 812 may establish the second NETCONF session based on the transmitted message.

In operation 1306, in a case that the reset process is not performed in the NETCONF server 811, the NETCONF client 812 may establish the second NETCONF session with the NETCONF server 811 by using the second connection information.

For example, in a case that the reset process is not performed in the NETCONF server 811, the NETCONF client 812 may receive, from the NETCONF server 811, a message for ‘call home’ configured by using the second connection information. The NETCONF client 812 may establish the second NETCONF session based on the received message.

According to the above-described operations 1301 to 1306, the NETCONF client 812 may support both the first connection information and the second connection information. In a case that the reset process is performed in the NETCONF server 811, the NETCONF client 812 may establish the second NETCONF session connection with the NETCONF server 811 by using the first connection information. In a case that the reset process is not performed in the NETCONF server 811, the NETCONF client 812 may establish the second NETCONF session connection with the NETCONF server 811 by using the second connection information.

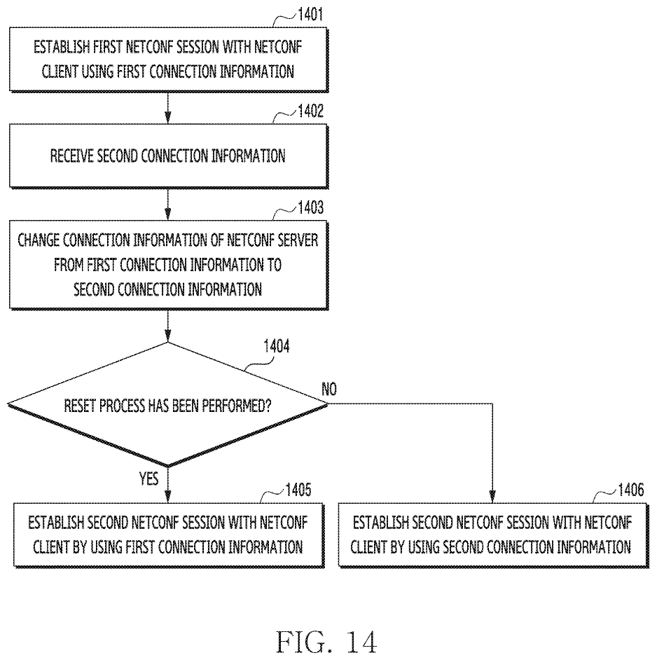

FIG. 14 is a flowchart related to an operation of a NETCONF server in a case that connection information is changed according to an embodiment of the disclosure.

Referring to FIG. 14, in operation 1401, a NETCONF server 811 may establish a first NETCONF session with a NETCONF client 812 by using first connection information.

For example, connection information of the NETCONF server 811 may be set to the first connection information. The first connection information may be default connection information of the NETCONF server 811. Connection information of the NETCONF client 812 may be set to the first connection information. The first connection information may be default connection information of the NETCONF client 812. In a case that the connection information of the NETCONF client 812 and the connection information of the NETCONF server 811 are identically set to the first connection information, the NETCONF client 812 and the NETCONF server 811 may establish the first NETCONF session by using the first connection information.

The first connection information may be related to at least one of information on a user account of the NETCONF client 812 and the NETCONF server 811, information on a secure shell (SSH) port for ‘call home’, information on an SSH server port, information on a transport layer security (TLS) port for ‘call home’, or information on a TLS server port. As an example, the first connection information may be set according to at least one of Tables 1 to 4.

In operation 1402, the NETCONF server 811 may receive second connection information from the NETCONF client 812. For example, the NETCONF server 811 may receive the second connection information from the NETCONF client 812 through the first NETCONF session.

For example, the second connection information may be related to at least one of information on a user account of the NETCONF client 812 and the NETCONF server 811, information on a secure shell (SSH) port for ‘call home’, information on an SSH server port, information on a transport layer security (TLS) port for ‘call home’, or information on a TLS server port. As an example, the second connection information may be managed in the NETCONF client 812.

In operation 1403, the NETCONF server 811 may change the connection information of the NETCONF server from the first connection information to the second connection information. For example, the NETCONF server 811 may change the connection information of the NETCONF server 811 from the first connection information to the second connection information in response to receiving the second connection information from the NETCONF client 812.

For example, the NETCONF server 811 may change a name of the user account. For example, the NETCONF server 811 may change a password of the user account. The NETCONF server 811 may change the SSH port for ‘call home’. The NETCONF server 811 may change the SSH server port. The NETCONF server 811 may change the TLS port for ‘call home’. The NETCONF server 811 may change the TLS server port.

According to an embodiment, the NETCONF server 811 may close the first NETCONF session based on changing the connection information of the NETCONF server 811 from the first connection information to the second connection information. The NETCONF server 811 may close the first NETCONF session based on the connection information of the NETCONF server 811 being changed. After the connection information of the NETCONF server 811 is changed, the NETCONF server 811 may deactivate the first connection information. The NETCONF server 811 may activate only the second connection information.

In operation 1404, the NETCONF server 811 may identify whether a reset process has been performed. For example, after the connection information of the NETCONF server 811 is changed from the first connection information to the second connection information, the NETCONF server 811 may identify whether the reset process has been performed.

According to an embodiment, the NETCONF server 811 may receive, from the NETCONF client 812, a message for indicating to perform the reset process. The NETCONF server 811 may perform the reset process based on the received message.

According to an embodiment, the NETCONF server 811 may identify an anomaly of the NETCONF server 811. The NETCONF server 811 may perform the reset process based on the anomaly of the NETCONF server 811. In a case that the NETCONF server 811 identifies the anomaly, the NETCONF server 811 may perform the reset process by itself.

In operation 1405, in a case that the reset process is performed in the NETCONF server 811, the NETCONF server 811 may establish a second NETCONF session with the NETCONF client 812 by using the first connection information. According to an embodiment, in a case that the reset process is performed, the NETCONF server 811 may initialize the connection information of the NETCONF server 811. In a case that the reset process is performed in the NETCONF server 811, the connection information of the NETCONF server 811 may be set to the first connection information. The first connection information may be stored in persistent memory of the NETCONF server 811. In a case that the reset process is performed in the NETCONF server 811, the first connection information may be set to the connection information of the NETCONF server 811.

For example, in a case that the reset process is performed in the NETCONF server 811, the NETCONF server 811 may receive, from the NETCONF client 812, a message for ‘call home’ configured by using the first connection information. The NETCONF server 811 may establish the second NETCONF session based on the received message.

For example, in a case that the reset process is performed in the NETCONF server 811, the NETCONF server 811 may transmit, to the NETCONF client 812, a message for ‘call home’ configured by using the first connection information. The NETCONF server 811 may establish the second NETCONF session based on the transmitted message.

In operation 1406, in a case that the reset process is not performed in the NETCONF server 811, the NETCONF server 811 may establish the second NETCONF session with the NETCONF client 812 by using the second connection information. For example, in a case that the reset process is not performed in the NETCONF server 811, the connection information of the NETCONF server 811 may be maintained as the second connection information. The NETCONF server 811 may establish the second NETCONF session with the NETCONF client 812 by using the second connection information. For example, the NETCONF client 812 and the NETCONF server 811 may establish the second NETCONF session by using the message (or the second connection information) for performing ‘call home’ configured by using the second connection information. The NETCONF server 811 may perform a call home procedure with the NETCONF client 812 by using the second connection information.

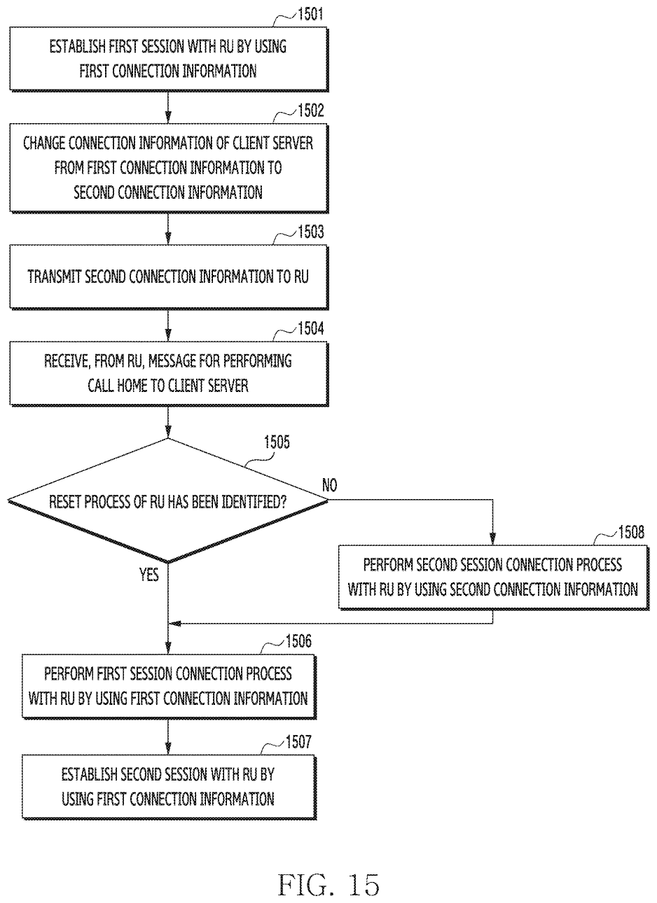

FIG. 15 is a flowchart related to an operation of a client server in a case that connection information is changed according to an embodiment of the disclosure.

Referring to FIG. 15, a client server described below may be an example of the above-described NETCONF client 812. For example, the client server may include at least one of a DU 210 or an SMO 610. An RU 220 described below may be an example of the above-described NETCONF server 811.

In operation 1501, the client server (or a processor of the client server, or an electronic device performed by the client server) may establish a first session (e.g., a first NETCONF session) with the RU 220 by using first connection information. For example, the client server may establish the first session with the RU 220 by using the first connection information which is connection information of the client server. Operation 1501 may correspond to operation 1301 of FIG. 13.

In operation 1502, the client server may change the connection information of the client server from the first connection information to second connection information. For example, while the first session is established, the client server may change the connection information of the client server from the first connection information to the second connection information. Operation 1502 may correspond to operation 1302 of FIG. 13.

For example, the first connection information and the second connection information may be related to at least one of information on a user account of the client server and the RU 220, information on a secure shell (SSH) port for call home, information on an SSH server port, information on a transport layer security (TLS) port for call home, or information on a TLS server port.

In operation 1503, the client server may transmit the second connection information to the RU 220. For example, the client server may transmit the second connection information to the RU 220 so that connection information of the RU 220 is changed from the first connection information to the second connection information. Operation 1503 may correspond to operation 1303 of FIG. 13.

In operation 1504, the client server may receive, from the RU 220, a message for performing call home to the client server. For example, based on transmitting the second connection information to the RU 220, the client server may receive, from the RU 220, the message for performing call home to the client server.

According to an embodiment, the message for performing call home to the client server may be configured based on one of the first connection information and the second connection information. For example, information for configuring the message for performing call home to the client server may be determined according to whether a reset process is performed in the RU 220. Therefore, in operation 1505, the client server may identify whether the reset process of the RU 220 has been performed.

In operation 1505, the client server may determine whether the reset process of the RU 220 has been identified. For example, in response to receiving the message, the client server may determine whether the reset process of the RU 220 has been identified. The client server may determine whether to use the second connection information to establish a second session according to whether the reset process has been identified.

In operation 1508, in a case that the reset process of the RU 220 is not identified, the client server may perform a second session connection process with the RU 220 by using the second connection information. For example, based on that the reset process of the RU 220 is not identified, the client server may perform the second session connection process with the RU 220 by using the second connection information. The second session connection process may be performed by using the second connection information.

According to an embodiment, the client server may fail to identify the reset process of the RU 220 even though the reset process is performed in the RU 220. The client server may fail in the second session connection process. For example, the reset process of the RU 220 may be performed based on an anomaly of the RU 220. The reset process performed based on the anomaly of the RU 220 may not be identified in the client server. The client server may perform operation 1506 based on the failure of the second session connection process.

Although not illustrated, the client server may fail to identify the reset process of the RU 220, but the reset process may not have been performed in the RU 220. In this case, the connection information of the RU 220 may be maintained as the second connection information. The client server may succeed in the second session connection process. The client server may establish the second session with the RU 220 based on the second session connection process. The client server may receive a message for performing call home to the client server through the session connection process. The message may be configured based on the second connection information. The client server may establish the second session with the RU 220 by using the second connection information.

In operation 1506, in a case that the reset process of the RU 220 is identified or the second session connection process fails, the client server may perform a first session connection process with the RU 220 by using the first connection information.

According to an embodiment, the client server may transmit, to the RU 220, a message for indicating to perform the reset process. The RU 220 may perform the reset process based on the message. In a case that the client server transmits, to the RU 220, the message for indicating to perform the reset process, the client server may identify the reset process of the RU 220. In a case that the client server identifies the reset process of the RU 220, the client server may perform the first session connection process with the RU 220 by using the first connection information. For example, the client server may identify that the received message has been configured based on the first connection information. The client server may perform the first session connection process based on the received message.

In operation 1507, the client server may establish the second session (e.g., a second NETCONF session) with the RU 220 by using the first connection information. The client server may establish the second session with the RU 220 based on a success of the first session connection process. For example, the client server may perform operation 1507 based on receiving a message for performing call home to the client server. The message may be configured based on the first connection information.

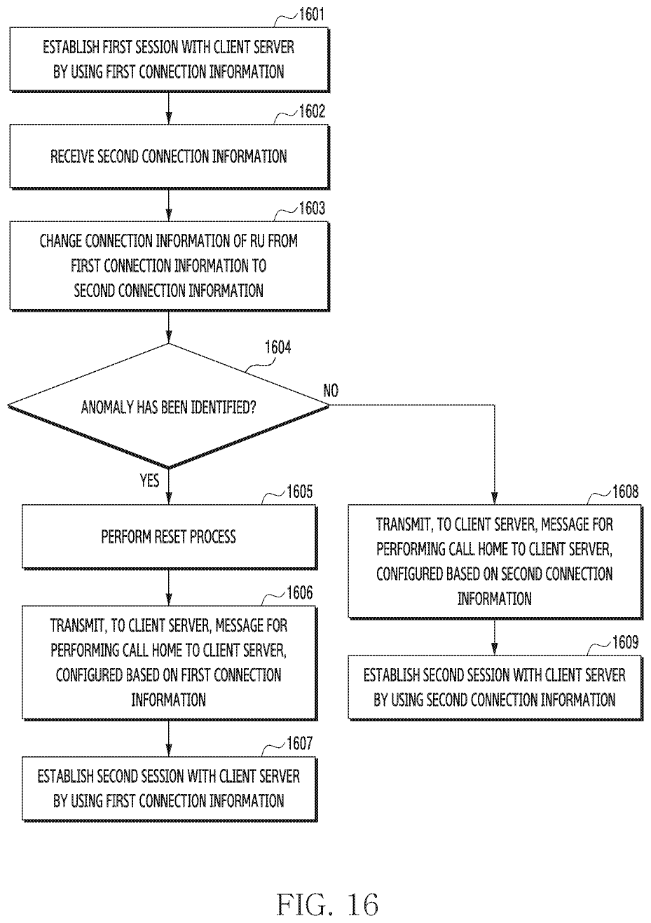

FIG. 16 is a flowchart related to an operation of an RU in a case that connection information is changed according to an embodiment of the disclosure.

Referring to FIG. 16, a client server described below may be an example of the above-described NETCONF client 812. For example, the client server may include at least one of a DU 210 or an SMO 610. An RU 220 described below may be an example of the above-described NETCONF server 811.

In operation 1601, the RU 220 (or a processor of the RU 220, or an electronic device performed by the RU 220) may establish a first session with the client server by using first connection information. The RU 220 may establish the first session with the client server by using the first connection information which is connection information of the RU 220. Operation 1601 may correspond to operation 1401 of FIG. 14.

In operation 1602, the RU 220 may receive second connection information from the client server. For example, while the first session is established, the RU 220 may receive the second connection information from the client server. Operation 1602 may correspond to operation 1402 of FIG. 14.

For example, the first connection information and the second connection information may be related to at least one of information on a user account of the client server and the RU 220, information on a secure shell (SSH) port for call home, information on an SSH server port, information on a transport layer security (TLS) port for call home, or information on a TLS server port.

In operation 1603, the RU 220 may change the connection information of the RU 220 from the first connection information to the second connection information. For example, based on receiving the second connection information, the RU 220 may change the connection information of the RU 220 from the first connection information to the second connection information. For example, based on receiving the second connection information from the client server, the RU 220 may change and store the connection information of the RU 220 as the second connection information. Operation 1603 may correspond to operation 1403 of FIG. 14.

In operation 1604, the RU 220 may determine whether an anomaly has been identified. For example, the RU 220 may determine whether the anomaly has been identified to determine whether to perform a reset process.

In operation 1605, in a case that the anomaly of the RU 220 is identified, the RU 220 may perform the reset process. For example, by performing the reset process of the RU 220, the RU 220 may initialize setting information of the RU 220. Based on performing the reset process, the RU 220 may set the connection information of the RU 220 to the first connection information. The RU 220 may set the connection information of the RU 220 to the first connection information by using the first connection information stored in persistent memory of the RU 220.

In operation 1606, the RU 220 may transmit, to the client server, a message for performing call home to the client server, configured based on the first connection information. Since the connection information of the RU 220 has been set to the first connection information through the reset process, the RU 220 may configure the message for performing call home to the client server based on the first connection information. The RU 220 may transmit the message to the client server.

In operation 1607, the RU 220 may establish a second session with the client server by using the first connection information. For example, the RU 220 may perform a first session connection process by transmitting, to the client server, the message for performing call home to the client server, configured based on the first connection information. The RU 220 may establish the second session with the client server based on a success of the first session connection process. Operation 1607 may correspond to operation 1405 of FIG. 14.

In operation 1608, in a case that the anomaly of the RU 220 is not identified, the RU 220 may transmit, to the client server, a message for performing call home to the client server, configured based on the second connection information. For example, in a case that the anomaly of the RU 220 is not identified, the reset process may not be performed. The connection information of the RU 220 may be maintained as the second connection information.

For example, since the connection information of the RU 220 has been maintained as the second connection information, the RU 220 may configure the message for performing call home to the client server based on the second connection information. The RU 220 may transmit the message to the client server.

In operation 1609, the RU 220 may establish the second session with the client server by using the second connection information. For example, the RU 220 may perform a second session connection process by transmitting, to the client server, the message for performing call home to the client server, configured based on the second connection information. The RU 220 may establish the second session with the client server based on a success of the second session connection process. Operation 1609 may correspond to operation 1406 of FIG. 14.

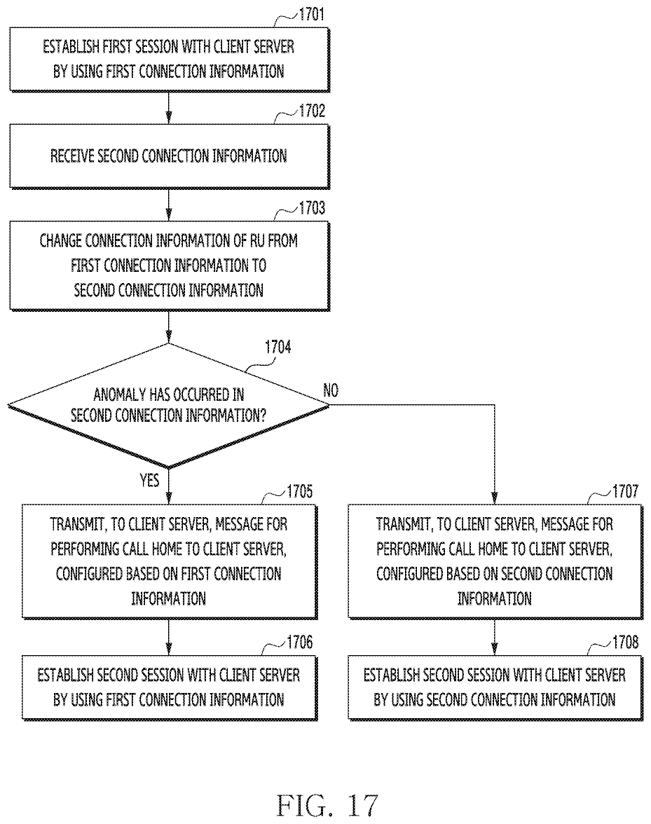

FIG. 17 is a flowchart related to an operation of an RU in a case that connection information is changed according to an embodiment of the disclosure.

Referring to FIG. 17, a client server described below may be an example of the above-described NETCONF client 812. For example, the client server may include at least one of a DU 210 or an SMO 610. An RU 220 described below may be an example of the above-described NETCONF server 811.

Referring to FIG. 17, in operation 1701, the RU 220 (or a processor of the RU 220, or an electronic device performed by the RU 220) may establish a first session with the client server by using first connection information. FIG. 17 may correspond to operation 1401 of FIG. 14 or operation 1601 of FIG. 16.

In operation 1702, the RU 220 may receive second connection information from the client server. Operation 1702 may correspond to operation 1402 of FIG. 14 or operation 1602 of FIG. 16.

In operation 1703, the RU 220 may change connection information of the RU 220 from the first connection information to the second connection information. Operation 1703 may correspond to operation 1403 of FIG. 14 or operation 1603 of FIG. 16.

In operation 1704, the RU 220 may identify (or determine) whether an anomaly has occurred in the second connection information. For example, the NETCONF server 811 may identify whether loss of the second connection information has occurred. For example, the NETCONF server 811 may identify that call home is not performed by using the second connection information. For example, the NETCONF server 811 may identify whether the second connection information fails to be used for session connection. For example, as a bug occurs in the NETCONF server 811, the NETCONF server 811 may identify whether the anomaly has occurred in the second connection information. As the NETCONF server 811 initializes a portion of functions of the NETCONF server 811 due to the bug, the NETCONF server 811 may identify whether the anomaly of the second connection information has occurred.

In operation 1705, in a case that the anomaly has occurred in the second connection information, the RU 220 may transmit, to the client server, a message for performing call home to the client server, configured based on the first connection information. Based on identifying that the anomaly has occurred in the second connection information, the RU 220 may transmit, to the client server, the message for performing call home to the client server, configured based on the first connection information. Operation 1705 may correspond to operation 1606 of FIG. 16.

In operation 1706, the RU 220 may establish a second session with the client server by using the first connection information. Operation 1706 may correspond to operation 1405 of FIG. 14 or operation 1607 of FIG. 16.

In operation 1707, in a case that the anomaly has not occurred in the second connection information, the RU 220 may transmit, to the client server, a message for performing call home to the client server, configured based on the second connection information. Based on identifying that the anomaly has not occurred in the second connection information, the RU 220 may transmit, to the client server, the message for performing call home to the client server, configured based on the second connection information. Operation 1707 may correspond to operation 1608 of FIG. 16.

In operation 1708, the RU 220 may establish the second session with the client server by using the second connection information. Operation 1708 may correspond to operation 1406 of FIG. 14 or operation 1609 of FIG. 16.

According to an embodiment, a client server may comprise a transceiver, at least one processor comprising processing circuitry, and memory, comprising one or more storage mediums, storing instructions. The instructions, when executed by the at least one processor individually or collectively, may cause the client server to establish a first session with a radio unit (RU) using first connection information which is connection information of the client server. The instructions, when executed by the at least one processor individually or collectively, may cause the client server to, while the first session is established, change the connection information of the client server from the first connection information to second connection information. The instructions, when executed by the at least one processor individually or collectively, may cause the client server to transmit, to the RU, the second connection information to change connection information of the RU from the first connection information to the second connection information. The instructions, when executed by the at least one processor individually or collectively, may cause the client server to, based on transmitting the second connection information to the RU, receive, from the RU, a message for performing call home to the client server. The instructions, when executed by the at least one processor individually or collectively, may cause the client server to, in response to receiving the message, determine whether a reset process of the RU is identified. The instructions, when executed by the at least one processor individually or collectively, may cause the client server to, according to whether the reset process of the RU has been identified, determine whether to use the second connection information to establish a second session with the RU.

According to an embodiment, the message for performing call home to the client server may be configured based on the first connection information.

According to an embodiment, the instructions, when executed by the at least one processor individually or collectively, may cause the client server to, based on the reset process of the RU being identified, perform a first session connection process using the first connection information. The instructions, when executed by the at least one processor individually or collectively, may cause the client server to, based on a success of the first session connection process, establish the second session with the RU.

According to an embodiment, the instructions, when executed by the at least one processor individually or collectively, may cause the client server to, based on that the reset process of the RU is not identified, perform a second session connection process with the RU using the second connection information. The instructions, when executed by the at least one processor individually or collectively, may cause the client server to, based on a failure of the second session connection process, perform the first session connection process with the RU using the first connection information. The instructions, when executed by the at least one processor individually or collectively, may cause the client server to, based on the success of the first session connection process, establish the second session with the RU.

According to an embodiment, the first connection information and the second connection information may be related to at least one of information on a user account of the client server and the RU, information on a secure shell (SSH) port for call home, information on an SSH server port, information on a transport layer security (TLS) port for call home, or information on a TLS server port.

According to an embodiment, the message for performing call home to the client server may be configured based on the second connection information.

According to an embodiment, the instructions, when executed by the at least one processor individually or collectively, may cause the client server to establish, using the second connection information, the second session with the RU.

According to an embodiment, the instructions, when executed by the at least one processor individually or collectively, may cause the client server to, based on transmitting a message for indicating to perform the reset process to the RU, identify the reset process of the RU.

According to an embodiment, the reset process of the RU may be performed based on an anomaly of the RU. The reset process of the RU performed based on the anomaly of the RU may not be identified by the client server.

According to an embodiment, the client server may comprise at least one of a distributed unit (DU) or service management and orchestration (SMO).

According to an embodiment, a radio unit (RU) may comprise a transceiver, at least one processor comprising processing circuitry, and memory, comprising one or more storage mediums, storing instructions. The instructions, when executed by the at least one processor individually or collectively, may cause the RU to establish a first session with a client server using first connection information which is connection information of the RU. The instructions, when executed by the at least one processor individually or collectively, may cause the RU to, while the first session is established, receive second connection information from the client server. The instructions, when executed by the at least one processor individually or collectively, may cause the RU to, based on receiving the second connection information, change the connection information of the RU from the first connection information to the second connection information. The instructions, when executed by the at least one processor individually or collectively, may cause the RU to, after the connection information of the RU is changed from the first connection information to the second connection information, in response to identifying an anomaly of the RU, perform a reset process. The instructions, when executed by the at least one processor individually or collectively, may cause the RU to, after the reset process is performed, transmit, to the client server, a message for performing call home to the client server configured based on the first connection information.

According to an embodiment, the instructions, when executed by the at least one processor individually or collectively, may cause the RU to, based on transmitting the message to the client server, establish a second session with the client server.

According to an embodiment, the instructions, when executed by the at least one processor individually or collectively, may cause the RU to, based on receiving the second connection information from the client server, change and store the connection information of the RU as the second connection information. The instructions, when executed by the at least one processor individually or collectively, may cause the RU to, based on performing the reset process, set the connection information of the RU to the first connection information.

According to an embodiment, the first connection information and the second connection information may be related to at least one of information on a user account of the client server and the RU, information on a secure shell (SSH) port for call home, information on an SSH server port, information on a transport layer security (TLS) port for call home, or information on a TLS server port.

According to an embodiment, the client server may comprise at least one of a distributed unit (DU) or service management and orchestration (SMO).

According to an embodiment, a method performed by a client server may comprise establishing a first session with a radio unit (RU) using first connection information which is connection information of the client server. The method may comprise, while the first session is established, changing the connection information of the client server from the first connection information to second connection information. The method may comprise transmitting, to the RU, the second connection information to change connection information of the RU from the first connection information to the second connection information. The method may comprise, based on transmitting the second connection information to the RU, receiving, from the RU, a message for performing call home to the client server. The method may comprise, in response to receiving the message, determining whether a reset process of the RU is identified. The method may comprise, according to whether the reset process of the RU has been identified, determining whether to use the second connection information to establish a second session with the RU.

According to an embodiment, the message for performing call home to the client server may be configured based on the first connection information.

According to an embodiment, the method may comprise, based on the reset process of the RU being identified, performing a first session connection process using the first connection information. The method may comprise, based on a success of the first session connection process, establishing the second session with the RU.

According to an embodiment, the first connection information and the second connection information may be related to at least one of information on a user account of the client server and the RU, information on a secure shell (SSH) port for call home, information on an SSH server port, information on a transport layer security (TLS) port for call home, or information on a TLS server port.

According to an embodiment, a method performed by a radio unit (RU) may comprise establishing a first session with a client server using first connection information which is connection information of the RU. The method may comprise, while the first session is established, receiving second connection information from the client server. The method may comprise, based on receiving the second connection information, changing the connection information of the RU from the first connection information to the second connection information. The method may comprise, after the connection information of the RU is changed from the first connection information to the second connection information, in response to identifying an anomaly of the RU, performing a reset process. The method may comprise, after the reset process is performed, transmitting, to the client server, a message for performing call home to the client server configured based on the first connection information.

In According to an embodiment, one or more non-transitory computer-readable storage media stores one or more computer programs including computer-executable instructions. The computer-executable instructions, when executed by one or more processors of a client server individually or collectively, cause the client server to perform operations are provided. The operations include establishing a first session with a radio unit (RU) using first connection information which is connection information of the client server, while the first session is established, changing the connection information of the client server from the first connection information to second connection information, transmitting, to the RU, the second connection information to change connection information of the RU from the first connection information to the second connection information, based on transmitting the second connection information to the RU, receiving, from the RU, a message for performing call home to the client server, in response to receiving the message, determining whether a reset process of the RU is identified, and according to whether the reset process of the RU has been identified, determining whether to use the second connection information to establish a second session with the RU.

According to the above-described embodiment, even in a case that connection information of a client server (e.g., an SMO 610 or a DU 210) and connection information of an RU are different, session connection between the client server and the RU may be automatically performed. Even in a case that the connection information of the client server (e.g., the SMO 610 or the DU 210) and the connection information of the RU are different, a session may be established without artificial intervention of a user. The client server may always support first connection information. Even in a case that the connection information of the client server is set to second connection information, the client server may establish a session with the RU by using the first connection information.

Methods according to embodiments described in claims or specifications of the disclosure may be implemented as a form of hardware, software, or a combination of hardware and software.

In a case of implementing as software, a computer-readable storage medium for storing one or more programs (software module) may be provided. The one or more programs stored in the computer-readable storage medium are configured for execution by one or more processors in an electronic device. The one or more programs include instructions that cause the electronic device to execute the methods according to embodiments described in claims or specifications of the disclosure. The one or more programs may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. In the case of being distributed online, at least part of the computer program product may be temporarily generated or at least temporarily stored in the machine-readable storage medium, such as memory of the manufacturer's server, the application store's server, or a relay server.

Such a program (software module, software) may be stored in random access memory, non-volatile memory including flash memory, read only memory (ROM), electrically erasable programmable read only memory (EEPROM), a magnetic disc storage device, an optical storage device (e.g., a compact disc-ROM (CD-ROM), digital versatile discs (DVDs), or other formats), or a magnetic cassette. Alternatively, it may be stored in memory configured with a combination of some or all of them. In addition, a plurality of configuration memories may be included.

Additionally, a program may be stored in an attachable storage device that may be accessed through a communication network such as the Internet, Intranet, local area network (LAN), wide area network (WAN), or storage area network (SAN), or a combination thereof. Such a storage device may be connected to a device performing an embodiment of the disclosure through an external port. In addition, a separate storage device on the communication network may also be connected to a device performing an embodiment of the disclosure.

In the above-described specific embodiments of the disclosure, components included in the disclosure are expressed in the singular or plural according to the presented specific embodiment. However, the singular or plural expression is selected appropriately according to a situation presented for convenience of explanation, and the disclosure is not limited to the singular or plural component, and even components expressed in the plural may be configured in the singular, or a component expressed in the singular may be configured in the plural.

According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be executed sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A client server comprising:
a transceiver;
memory, comprising one or more storage media, storing instructions; and
at least one processor comprising processing circuitry,
wherein the instructions, when executed by the at least one processor individually or collectively, cause the client server to:
establish a first session with a radio unit (RU) using first connection information which is connection information of the client server,
while the first session is established, change the connection information of the client server from the first connection information to second connection information,
transmit, to the RU, the second connection information to change connection information of the RU from the first connection information to the second connection information,
based on transmitting the second connection information to the RU, receive, from the RU, a message for performing call home to the client server,
in response to receiving the message, determine whether a reset process of the RU is identified, and
according to whether the reset process of the RU has been identified, determine whether to use the second connection information to establish a second session with the RU.

2. The client server of claim 1, wherein the message for performing call home to the client server is configured based on the first connection information.

3. The client server of claim 2, wherein the instructions, when executed by the at least one processor individually or collectively, further cause the client server to:
based on the reset process of the RU being identified, perform a first session connection process using the first connection information, and
based on a success of the first session connection process, establish the second session with the RU.

4. The client server of claim 3, wherein the instructions, when executed by the at least one processor individually or collectively, further cause the client server to:
based on that the reset process of the RU is not identified, perform a second session connection process with the RU using the second connection information,
based on a failure of the second session connection process, perform the first session connection process with the RU using the first connection information, and
based on the success of the first session connection process, establish the second session with the RU.

5. The client server of claim 1, wherein the first connection information and the second connection information are related to at least one of information on a user account of the client server and the RU, information on a secure shell (SSH) port for call home, information on an SSH server port, information on a transport layer security (TLS) port for call home, or information on a TLS server port.

6. The client server of claim 1, wherein the message for performing call home to the client server is configured based on the second connection information.

7. The client server of claim 6, wherein the instructions, when executed by the at least one processor individually or collectively, further cause the client server to establish, using the second connection information, the second session with the RU.

8. The client server of claim 1, wherein the instructions, when executed by the at least one processor individually or collectively, further cause the client server to, based on transmitting a message for indicating to perform the reset process to the RU, identify the reset process of the RU.

9. The client server of claim 1,
wherein the reset process of the RU is performed based on an anomaly of the RU, and
wherein the reset process of the RU performed based on the anomaly of the RU is not identified by the client server.

10. The client server of claim 1, wherein the client server comprises at least one of a distributed unit (DU) or service management and orchestration (SMO).

11. A radio unit (RU) comprising:
a transceiver;
memory, comprising one or more storage media, storing instructions; and
at least one processor comprising processing circuitry,
wherein the instructions, when executed by the at least one processor individually or collectively, cause the RU to:
establish a first session with a client server using first connection information which is connection information of the RU,
while the first session is established, receive second connection information from the client server,
based on receiving the second connection information, change the connection information of the RU from the first connection information to the second connection information,
after the connection information of the RU is changed from the first connection information to the second connection information, in response to identifying an anomaly of the RU, perform a reset process, and
after the reset process is performed, transmit, to the client server, a message for performing call home to the client server configured based on the first connection information.

12. The RU of claim 11, wherein the instructions, when executed by the at least one processor individually or collectively, further cause the RU to, based on transmitting the message to the client server, establish a second session with the client server.

13. The RU of claim 11, wherein the instructions, when executed by the at least one processor individually or collectively, further cause the RU to:
based on receiving the second connection information from the client server, change and store the connection information of the RU as the second connection information, and
based on performing the reset process, set the connection information of the RU to the first connection information.

14. The RU of claim 11, wherein the first connection information and the second connection information are related to at least one of information on a user account of the client server and the RU, information on a secure shell (SSH) port for call home, information on an SSH server port, information on a transport layer security (TLS) port for call home, or information on TLS server port.

15. The RU of claim 11, wherein the client server comprises at least one of distributed unit (DU) or service management and orchestration (SMO).

16. A method performed by a client server, the method comprising:
establishing a first session with a radio unit (RU) using first connection information which is connection information of the client server;
while the first session is established, changing the connection information of the client server from the first connection information to second connection information;
transmitting, to the RU, the second connection information to change connection information of the RU from the first connection information to the second connection information;
based on transmitting the second connection information to the RU, receiving, from the RU, a message for performing call home to the client server;
in response to receiving the message, determining whether a reset process of the RU is identified; and
according to whether the reset process of the RU has been identified, determining whether to use the second connection information to establish a second session with the RU.

17. The method of claim 16, wherein the message for performing call home to the client server is configured based on the first connection information.

18. The method of claim 17, further comprising:
based on the reset process of the RU being identified, performing a first session connection process using the first connection information; and
based on a success of the first session connection process, establishing the second session with the RU.

19. The method of claim 16, wherein the first connection information and the second connection information are related to at least one of information on a user account of the client server and the RU, information on a secure shell (SSH) port for call home, information on an SSH server port, information on a transport layer security (TLS) port for call home, or information on TLS server port.

20. A method performed by a radio unit (RU), the method comprising:
establishing a first session with a client server using first connection information which is connection information of the RU;
while the first session is established, receiving second connection information from the client server;
based on receiving the second connection information, changing the connection information of the RU from the first connection information to the second connection information;
after the connection information of the RU is changed from the first connection information to the second connection information, in response to identifying an anomaly of the RU, performing a reset process; and
after the reset process is performed, transmitting, to the client server, a message for performing call home to the client server configured based on the first connection information.
